(19) United States
(12) Patent Application Publication
(10) Pub. No.: US 2014/0184973 A1
(43) Pub. Date: Jul. 3, 2014

(54) LIQUID CRYSTAL DISPLAY

(71) Applicant: Samsung Display Co., Ltd., Yongin-City (KR)

(72) Inventors: Sung Hoon KIM, Seoul (KR); Seung-Ho BAE, Cheonan-si (KR)

(73) Assignee: Samsung Display Co., Ltd., Yogin-City (KR)

(21) Appl. No.: 14/139,531

(22) Filed: Dec. 23, 2013

(30) Foreign Application Priority Data
Jan. 3, 2013 (KR) 10-2013-0000767

(51) Int. Cl. G02F 1/1362; G02F 1/1335

(52) U.S. Cl. CPC G02F 1/136209; G02F 1/133514
USPC 349/43

(57) ABSTRACT

A liquid crystal display includes: a first insulation substrate; a plurality of color filters positioned on the first insulation substrate; a plurality of gate lines and a plurality of data lines positioned on the plurality of color filters; a plurality of thin film transistors positioned on the plurality of color filters and connected to the plurality of gate lines and the plurality of data lines; a plurality of pixel electrodes connected to the plurality of thin film transistors; a second insulation substrate facing the first insulation substrate; a liquid crystal layer positioned between the first insulation substrate and the second insulation substrate; and a backlight unit positioned behind the second insulation substrate, wherein the thin film transistors are not formed on the second insulation substrate and anti-glare elements are provided in front of at least one of the data lines and gate lines for respectively reducing or preventing the reflection of ambient light to a user from the data lines or the gate lines respectively.

### CROSS-REFERENCE TO RELATED APPLICATION

This application claims priority to and the benefit of Korean Patent Application No. 10-2013-0000767 filed in the Korean Intellectual Property Office on Jan. 3, 2013, the entire contents of which application are incorporated herein by reference.

### BACKGROUND

(a) Field of Disclosure

The present invention relates to a liquid crystal display.

(b) Description of Related Technology

Liquid crystal displays are now widely used as one type of thin (flat or curved) panel display. A liquid crystal display (LCD) typically has two spaced apart display panels and opposed electric field generating electrodes may be provided on these spaced apart display panels, for example pixel electrodes on one and a common electrode formed on the other. A liquid crystal material layer is then interposed between the spaced apart panels. During operation of the liquid crystal display, different voltages are applied to the field generating electrodes so as to generate respective electric fields extending through the liquid crystal layer, and then the alignments of liquid crystal molecules in the liquid crystal layer are determined by the created electric fields. Polarization of incident light may then be controlled, thereby forming a desired image to be viewed by a user of the display.

As the size of liquid crystal displays is increased, it has become common to integrally incorporate one or more panel driver circuits that output signals such as gate lines driving signals, data lines driving signals, and one or more common voltages to respective field generating electrodes of the liquid crystal display. For example, a mounting technique of flip chip bonding may be used for connecting the driving chip(s) to the other circuitry of the substrate by contacting flip chip bonding terminals of the driving chip with the substrate.

When mounting the driving circuit chip(s) to the liquid crystal display by using this mounting technique, it may become advantageous to position a backlighting providing backlight unit under the common electrode panel, and to position the pixel electrodes panel over the common electrode panel such that the image that is to be viewed by the user appears on or above a top surface of the pixel electrodes panel. In other words, light from the backlight first passes through the common electrode panel, then through the liquid crystal layer and thereafter through the pixel electrodes and thin film transistors array panel to thereby display the desired image to a user facing an outer surface of the TFT array/pixel electrodes panel. (In the foregoing and as a first frame of reference, the user is deemed to be positioned “above” the TFT array substrate, a liquid crystal material layer is deemed to be disposed “below” the TFT array substrate, a second substrate (e.g., a common electrode substrate) is deemed to be disposed “below” the LC material layer and the backlighting unit is deemed to be disposed “below” the second substrate. In an alternate, second frame of reference, the user is in “front” of the TFT array substrate, the LC material layer is “behind” the TFT array substrate, the second substrate (e.g., a common electrode substrate) is deemed to be disposed “behind” the LC material layer and the backlighting unit is deemed to be disposed “behind” the second substrate. Either of the first and second frames of reference or even further ones (e.g., the drawing page) may be used herein to describe relations between described parts.)

More specifically, the user views an outwardly-directed side (alternatively, a “front” side) of the thin film transistor (TFT) array panel, and in this case, the light rays which flow from the further below (or behind), common electrode panel may come to strike metallic or otherwise reflective surfaces of the thin film transistor array panel such as the various signal lines (yet more specifically, such as gate lines, data lines, storage lines, etc.) formed on the thin film transistor array panel only to be undesirably reflected in undesired directions by such reflective surfaces of the thin film transistor array panel. Alternatively or additionally, ambient lights from the outside of the display may come to strike metallic or otherwise reflective surfaces of the thin film transistor array panel such as the various signal lines formed on the thin film transistor array panel only to be undesirably reflected in undesired directions by such reflective surfaces of the thin film transistor array panel. As a result, the one or more undesirably reflected lights might be seen by the user as forming artifacts in the displayed image; such that the display quality is deteriorated.

It is to be understood that this background of the technology section is intended to provide useful background for understanding the here disclosed technology and as such, the technology background section may include ideas, concepts or recognitions that were not part of what was known or appreciated by those skilled in the pertinent art prior to corresponding invention dates of subject matter disclosed herein.

### SUMMARY

The present disclosure of invention provides a liquid crystal display in which glare from exterior (ambient) light is reduced or prevented by providing light absorbing elements in front of reflective surfaces (e.g., data lines and gate lines) of a thin film transistor array panel used in a display device having a second substrate disposed spaced apart and behind the thin film transistor array panel and having a backlighting unit disposed behind the second substrate.

A liquid crystal display according to an exemplary embodiment of the present disclosure includes: a first insulation substrate; a plurality of color filters positioned on the first insulation substrate; a plurality of gate lines and a plurality of data lines positioned on the plurality of color filters; a plurality of thin film transistors positioned on the plurality of color filters and connected to the plurality of gate lines and the plurality of data lines; a plurality of pixel electrodes connected to the plurality of thin film transistors; a second insulation substrate facing the first insulation substrate; a common electrode optionally formed on the second insulation substrate or having parts thereof formed on the first insulation substrate; a liquid crystal layer positioned between the first insulation substrate and the second insulation substrate; and a backlight unit positioned behind the second insulation substrate, wherein the thin film transistors are not formed on the second insulation substrate and wherein anti-glare elements are provided in front of at least one of the data lines and gate lines for respectively reducing or preventing the reflection of ambient light to a user respectively from the data lines or the gate lines of the in front, first insulation substrate.

A first insulating layer positioned on the plurality of color filters may be further included.

A first light blocking member positioned on the first insulation substrate or the second insulation substrate may be further included, and the first light blocking member may be disposed at a position overlapping channel portions of the plurality of thin film transistors so as to block first light rays from the backlighting unit from affecting the channel regions.

A second light blocking member formed on the first insulation substrate and positioned between the plurality of color filters may be further included, and the second light blocking member may be disposed at a position overlapped by the data line.

The second light blocking member may be positioned under or on the plurality of color filters.

The plurality of color filters may be excluded from a region overlapping the gate line.

The gate line may be thicker than the data line.

A third light blocking member positioned between the first substrate and the gate line may be further included.

The plurality of color filters may be formed with respective heights thereof that are lower than a top surface of the adjacent gate line.

In the liquid crystal display according to an exemplary embodiment of the present disclosure, on the first insulation substrate of the thin film transistor array panel, after forming at least one of the color filter and the light blocking member, the gate line, the data line, and the pixel electrode are formed, and after forming the common electrode on the second insulation substrate facing the first insulation substrate, by positioning the backlight unit outside the second insulation substrate, the outside (ambient) light is not reflected by the signal lines (e.g., the gate lines and the data lines) of the thin film transistor array panel, and as a result, the display quality deterioration of the image displayed through the common electrode panel and the thin film transistor array panel caused by the light of the backlight may be prevented.

### BRIEF DESCRIPTION OF THE DRAWINGS

FIG. 1 is a schematic view of one pixel of a liquid crystal display according to an exemplary embodiment of the present disclosure of invention.

FIG. 2 is a layout view of a liquid crystal display according to an exemplary embodiment.

FIG. 3 is a cross-sectional view of the liquid crystal display of FIG. 2 taken along sectional line III-III of FIG. 2.

FIG. 4 is a cross-sectional view of a liquid crystal display according to another exemplary embodiment and also taken along sectional line III-III of the shared top view layout of FIG. 2.

FIG. 5 is a cross-sectional view of a liquid crystal display according to another exemplary embodiment taken along the line III-III of FIG. 2.

FIG. 6 is a cross-sectional view of a liquid crystal display according to another exemplary embodiment taken along the line III-III of FIG. 2.

FIG. 7 is a cross-sectional view of a liquid crystal display according to another exemplary embodiment taken along the line III-III of FIG. 2.

FIG. 8 is a cross-sectional view of a liquid crystal display according to another exemplary embodiment of the present invention taken along the line III-III of FIG. 2.

FIG. 9 is a cross-sectional view of a liquid crystal display according to another exemplary embodiment taken along the line III-III of FIG. 2.

FIG. 10 is a cross-sectional view of a liquid crystal display according to another exemplary embodiment taken along the line III-III of FIG. 2.

FIG. 11 is a cross-sectional view of a liquid crystal display according to another exemplary embodiment taken along the line III-III of FIG. 2.

### DETAILED DESCRIPTION

The present disclosure of invention will be described more fully hereinafter with reference to the accompanying drawings, in which exemplary embodiments in accordance with the present disclosure are shown. As those skilled in the art would realize after appreciating the present disclosure, the described embodiments may be modified in various different ways, all without departing from the spirit or scope of the present teachings.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

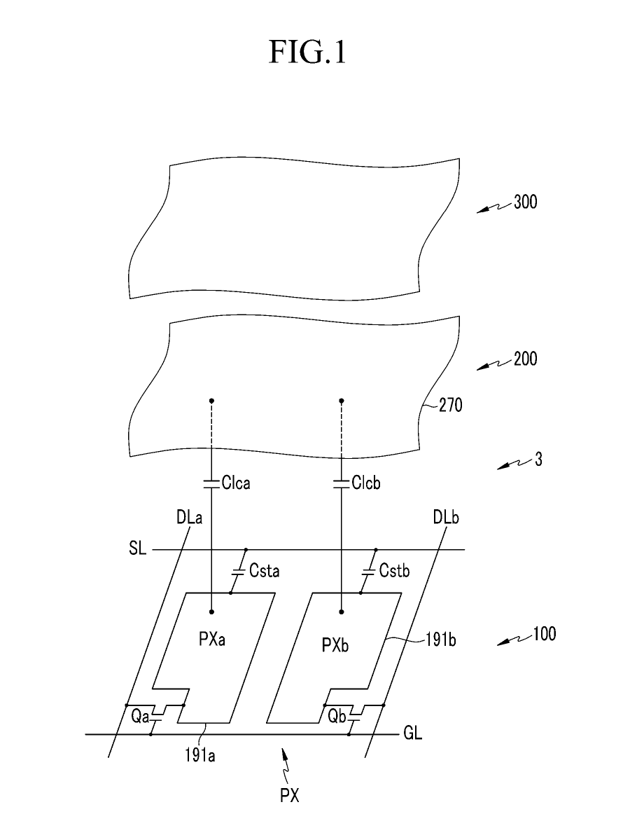

FIG. 1 is a schematic view of one pixel of a liquid crystal display according to an exemplary embodiment of the present disclosure of invention.

Referring to FIG. 1, a liquid crystal display in accordance with the present exemplary embodiment includes a first display panel 100 and a second display panel 200 facing each other, a liquid crystal layer 3 interposed between the first display panel 100 and the second display panel 200, and a backlight unit 300 positioned behind (or in an alternate frame of reference, “below”) the second display panel 200. It is to be understood that although FIG. 1 depicts the backlight unit 300 as being at the “top” of the drawing, the same drawing may be rotated 90 degrees counterclockwise such that light propagation is in a left to right sequence, starting with the rearward most (or in an alternate frame of reference, “lowest”) backlight providing unit 300 and then progressing through the second display panel 200, through the LC material layer 3, and through the first display panel 100 for subsequent perception by the eyes of a user (not shown, but understood to be facing the first display panel 100) of the LCD.

The first display panel 100 includes a plurality of signal lines including a plurality of gate lines GL, a plurality of paired sets of data lines DLa and DLb, and a plurality of storage electrode lines SL. The first display panel 100 also includes a plurality of pixel units PX having internal components that are operatively coupled to respective ones of adjacent ones of the signal lines (e.g., GL, DLa, DLb, SL).

In the illustrated embodiment, each pixel unit PX includes a pair of sub-pixels PXa and PXb, and each sub-pixel PXa/PXb respectively includes a respective switching element Qa/Qb, a respective subpixel electrode (191) forming a corresponding liquid crystal capacitor Clca/Clcb, and a respective storage electrode forming a corresponding storage capacitor Csta/Cstb.

In one class of embodiments, each switching element Qa/Qb is a three-terminal control element such as a thin film transistor (TFT) that is monolithically integrated on the lower panel 100. Each such TFT includes a control terminal (a.k.a. gate electrode) connected to the adjacent gate line GL, an input terminal (a.k.a. source electrode) connected to the adjacent data line DLa/DLb, and an output terminal (a.k.a. drain electrode) connected to the respective liquid crystal capacitor Clca/Clcb and to the respective storage capacitor Csta/Cstb.

In the illustrated example of FIG. 1, the respective liquid crystal capacitor Clca/Clcb has as one of its capacitor plates, a respective one of sub-pixel electrodes 191a/191b and as its opposed other capacitor plate, an opposed portion of the common electrode 270. The liquid crystal layer 3 which is interposed between the electrodes 191a/191b and 270 functions as a dielectric material of the respective LC capacitor. The common electrode 270 and the sub-pixel electrodes 191a/191b are composed of respective, electrically conductive and light-passing materials such as ITO, IZO, etc. The substrates (not explicitly shown in FIG. 1) on which the former are formed, are composed of respective, electrically-insulative and light-passing materials such as glass, plastic, etc.

The formed storage capacitors Csta/Cstb serve as a charge-storing assistants to the corresponding liquid crystal capacitors Clca/Clcb so that a respective charge fed in a horizontal scan period (1H) through the corresponding switching element Qa/Qb and into the respective set of liquid crystal capacitor Clcx and storage capacitor Cstx (where x here is a or b) may be retained for a longer period of time (e.g., at least one frame period). More specifically, the respective storage capacitor Cstx is formed with a portion of the storage electrode line SL serving as a first capacitor plate and an overlapped portion of the corresponding sub-pixel electrode 191a/191b serving as a opposed capacitor plate, with an appropriate insulator being interposed therebetween. A predetermined voltage such as a common voltage (Vcom) may be applied to the storage electrode line SL. In an alternate embodiment, a reference voltage other than Vcom may be applied to the storage electrode line SL after the Clcx/Cstx pair is first charged by the corresponding switching element Qx (where x here is a or b).

In one embodiment, the voltages charged onto the two liquid crystal capacitors Clca and Clcb of each pixel unit (PX) are established to slightly differ from each other so that side view visibility of the formed image is improved. For example, the data voltage applied to the liquid crystal capacitor Clca may be established to always be lower or higher than the data voltage applied to the other liquid crystal capacitor Clcb. When the voltages of the two liquid crystal capacitors Clca and Clcb are properly controlled, an image viewed from the lateral side may maximally approximates an image viewed head on from the frontal side, thereby improving the lateral visibility of the liquid crystal display.

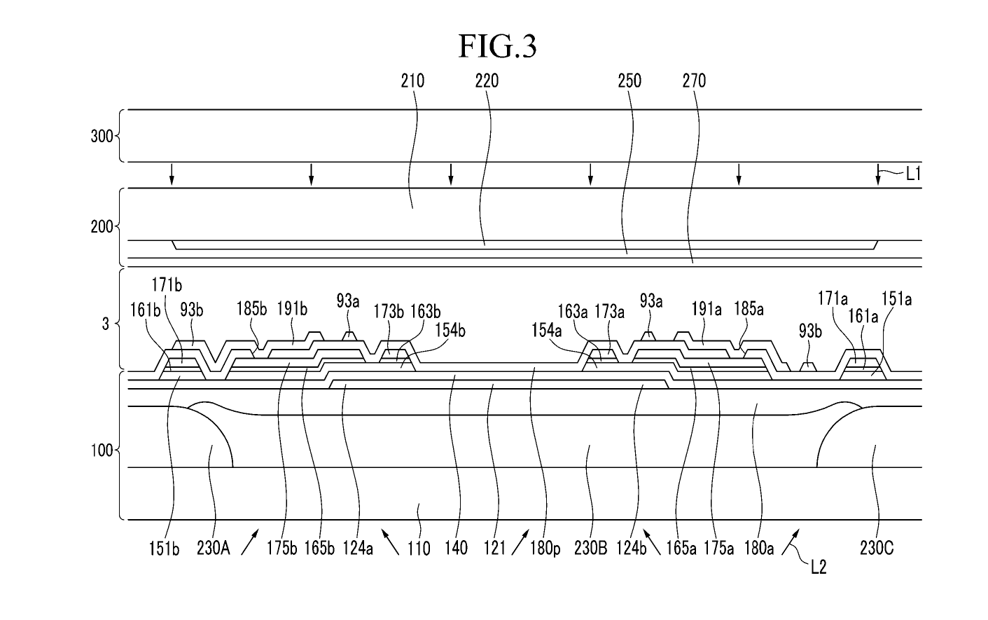

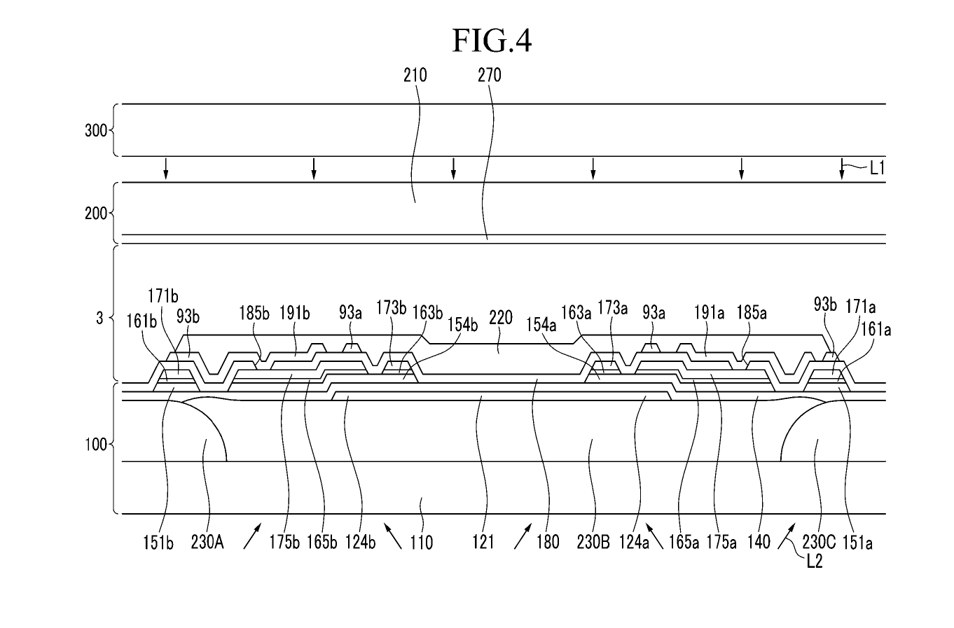

In the exemplary embodiment, the common electrode 270 is formed in the second display panel 200, however the present invention is not limited thereto, and in a case of a liquid crystal display according to another exemplary embodiment of the present invention, the common electrode 270 may be formed in the first display panel 100 including a plurality of signal lines and a plurality of pixels PX connected thereto. Also, the second display panel 200 does not include the thin film transistors. In other words, the second display panel 200 may function primarily to contain the liquid crystal material layer 3 between the spaced apart first and second display panels 100-200 and to pass therethrough the light from the more rearward backlighting unit 300. The second display panel 200 need not have any component thereon which needs to be precisely aligned to counterpart feature on the first display panel 100. It is within the contemplation of the present disclosure that second display panel 200 may include an LC alignment layer (not shown) for initially aligning molecules of the LC layer 3 before electric fields are established and/or that the second display panel 200 may integrally incorporate optical processing layers (not shown) such as a light polarization layer, a light diffusing layer and/or a prismatic optical processing layer. In one class of embodiments, the second display panel 200 may include features (e.g., black matrix 220 of FIG. 3) which do need to be aligned with relative precision to counterpart feature on the first display panel 100. In another class of embodiments, the function of the black matrix (e.g., 220 of FIG. 4) may be partially or fully provided by features of the first display panel 100.

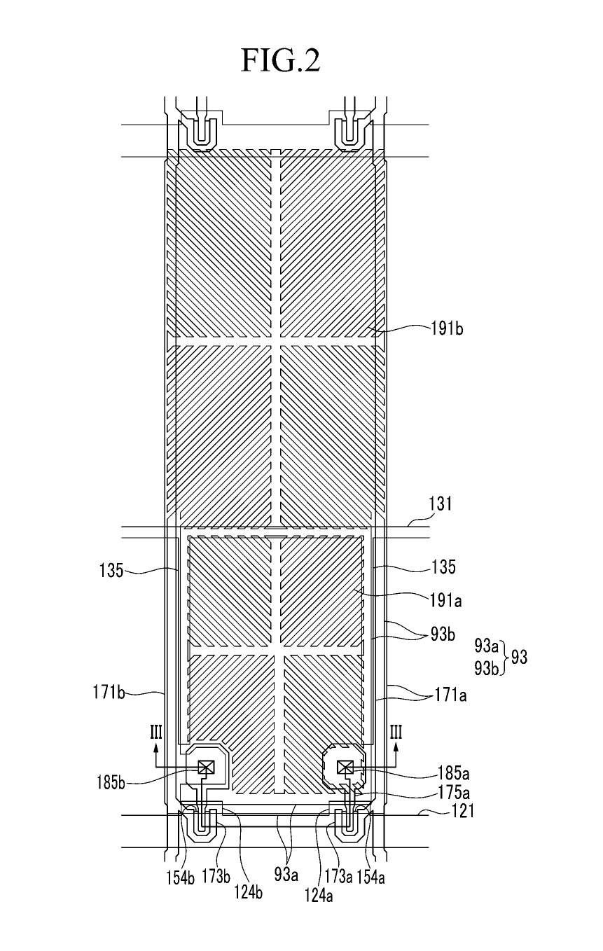

Next, a specific liquid crystal display according to an exemplary embodiment of the present invention will be described with reference to FIG. 2 and FIG. 3.

FIG. 2 is a top plan layout view of a first panel 100 of a liquid crystal display according to an exemplary embodiment of the present disclosure, and FIG. 3 is a cross-sectional view of the liquid crystal display of FIG. 2 taken along a line III-III and cutting through the second panel 200 and the backlighting unit 300 as well as through the first panel 100.

Referring to FIG. 2 and FIG. 3, a liquid crystal display the present exemplary embodiment includes the first display panel 100 and the second display panel 200 facing each other, the liquid crystal layer 3 interposed between the first display panel 100 and the second display panel 200, and the backlight unit 300 positioned outside (or in an alternate frame of reference, “behind”) the second display panel 200.

Firstly, the first display panel 100 will be described in more detail.

A base or first insulation substrate 110 is provided. A plurality of differently colored color filters 230A, 230B, and 230C are formed on the base or first insulation substrate 110. Each of the color filters 230A, 230B, and 230C may absorb or pass therethrough light rays of different wavelengths (e.g., so as to display a respective color, or pass through white light or absorb a predetermined set of wavelengths). In one embodiment, one of the first and third color filters 230A/230C and the second color filter 230B which respectively absorb in different ranges of the visible spectrum are partially overlapped with one another so that their absorption functions are additively provided where increased light absorption is desired, more specifically at positions respectively overlapped by a first data line 171a and by a second data line 171b, where the latter elements will be described later below. More specifically, the first color filter 230A overlaps with the second 230B under the position of the second data line 171b, and the second color filter 230B overlaps the third color filter 230C under the position of the first data line 171a. (Here, the term “under” is understood to refer to how these features are shown in FIG. 4.) It is to be understood with respect to FIG. 3 that it is a cross sectional view and that in at least one embodiment, the overlapping of the outer portions of second color filter 230B over the non-vertical sidewall edges of the first and third color filters, 230A and 230C extends in a direction perpendicular to the plane of drawing so that the overlapping of the color filters tracks the extending direction of the corresponding data lines 171a and 171b. Also it is to be understood with respect to FIG. 3 that formation of the illustrated embodiment includes the steps of first forming the first and third color filters, 230A and 230C to each have inwardly angled sidewall edges as shown and then to deposit the material of the second color filter 230B such that its outer edges overlap those of the first and third color filters, 230A and 230C at the locations that will be overlapped by the later-formed, first and second data lines 171a and 171b.

After the color filters are formed, a first insulating and planarizing layer 180a is disposed on top of the plurality of partially overlapping color filters 230A, 230B, and 230C. The first insulating layer 180a prevents respective pigments of the respective color filters 230A, 230B, and 230C from being exposed and leaching out to degrade overlying components (e.g., TFTs) of the first display panel 100. Additionally, the first insulating and planarizing layer 180a contains the plurality of color filters 230A, 230B, and 230C and prevents them from being lifted apart from one another. Thirdly, the first insulating and planarizing layer 180a removes a difference of heights of the plurality of color filters 230A, 230B, and 230C, thereby provides flatness (planarization). The first insulating layer 180a may include one or both of an organic insulator and an inorganic insulator (e.g., SiO, SiN, SiON).

Next, spaced apart gate lines 121 and storage electrode lines (131 and 135) are formed on top of the first insulating and planarizing layer 180a. The gate lines 121 are configured to transmit respective gate signals along corresponding rows of pixel units and as such, the gate lines extend mainly in a transverse direction. Each gate line 121 includes a plurality of integrally branching-out first gate electrodes 124a and second gate electrodes 124b where the respective TFTs are to be formed.

The storage electrode line includes stems 131 extending substantially parallel to the gate lines 121, and a plurality of storage electrodes 135 protruded from the stems 131. The shape and disposition of the storage electrode lines 131 and 135 may be altered in various manners.

Next, a gate insulating layer 140 is formed on the gate lines 121, the storage electrode lines 131 and 135, and the first insulating layer 180a. Then, a plurality of semiconductive islands 151a and 151b are formed on the gate insulating layer 140 for example with amorphous silicon or crystalline silicon to insulatively overlap the gate electrodes. Each of the semiconductor islands 151a and 151b includes a plurality of projections 154a and 154b protruding toward the gate electrodes 124a and 124b. Each of the semiconductors 151a and 151b may alternatively include a semiconductive oxide.

A plurality of pairs of ohmic contact members 161a, 161b, 163a, 163b, 165a, and 165b are formed on the semiconductors 151a and 151b. The ohmic contacts 161a, 161b, 163a, 163b, 165a, and 165b may be made of n+ hydrogenated amorphous silicon in which an n-type impurity is doped at a high concentration, or they may be formed of one or more silicides.

In a case that the semiconductors 151a and 151b include the semiconductive oxide, the ohmic contacts 161a, 161b, 163a, 163b, 165a, and 165b may be omitted.

A plurality of pairs of first and second data lines 171a and 171b and a plurality of pairs of first and second drain electrodes 175a and 175b are formed on the ohmic contact members 161a, 161b, 163a, 163b, 165a, and 165b and the gate insulating layer 140.

The data lines 171a and 171b transmit data signals and substantially extend in a longitudinal direction so as to cross the transverse gate lines 121 and the stems 131 of the storage electrode lines. The data lines 171a and 171b include first and second source electrodes 173a and 173b each patterned in a U-shape by extending toward the first and second gate electrodes 124a and 124b, and the first and second source electrodes 175a and 175b face the first and second source electrodes 173a and 173b with respect to the first and second gate electrodes 124a and 124b.

The drain electrodes 175a and 175b include one end portion extending upward, which is partially surrounded by the U-shaped first source electrode 173a, and another end portion having a wide area so as to be connected to another layer (to the corresponding pixel electrode).

However, the shape and arrangement of the data lines 171a and 171b including the first and second drain electrodes 175a and 175b may be modified in various ways.

The first and second gate electrodes 124a and 124b, the first and second source electrodes 173a and 173b, and the first and second drain electrodes 175a and 175b, along with the projections 154a and 154b of the first and second semiconductors 151a and 151b, correspondingly form the first and second TFTs, Qa and Qb. Each of the first and second TFTs, Qa and Qb has a channel formed in the projections 154a and 154b of the semiconductors 151a and 151b disposed between the first and second source electrodes and the first and second drain electrodes 175a and 175b, respectively.

The ohmic contacts 161a, 161b, 163a, 163b, 165a, and 165b are interposed between the projections 154a and 154b of the underlying semiconductors 151a and 151b and the overlying data lines 171a and 171h and drain electrode 175a and 175b, and may reduce the contact resistance therebetween. The semiconductors 151a and 151b include some exposed portions that are not covered with the data lines 171a and 171b and the drain electrodes 175a and 175b, such as portions located between the source electrodes 173a and 173b and the drain electrodes 175a and 175b.

The ohmic contact members 161a, 161b, 163a, 163b, 165a, and 165b, the data lines 171a, 171b, 173a, and 173b, and the drain electrodes 175a and 175b have the same planar pattern, and have substantially the same planar pattern as the semiconductive islands 151a and 151h except for exposed portions (channel regions) between the drain electrodes 175a and 175b and the source electrodes 173a and 173b.

A lower passivation film 180p made for example of a silicon nitride and/or a silicon oxide and/or a silicon oxinitride is formed on the data lines 171a and 171b, the drain electrodes 175a and 175b, and the exposed semiconductive islands 151a and 151b.

The lower passivation film 180p may alternatively be formed of an organic material.

A plurality of pixel electrodes 191 are formed on the lower passivation film 180p.

Each pixel electrode 191 includes the first sub-pixel electrode 191a and the second sub-pixel electrode 191b that are electrically separated from each other.

The overall shape of the first and second subpixel electrodes 191a and 191b is a quadrangle, and each includes a cross-shaped stem having a transverse stem and a longitudinal stem that are crossed. Also, each pixel electrode is divided into four sub-regions by the transverse stem and the longitudinal stem, and each of the sub-regions includes a plurality of fine branches as shown in FIG. 2.

The second sub-pixel electrode 191b has an extension portion that circumvents about a side edge of the first sub-pixel electrode 191a so as to connect with its respective TFT (154b). In one embodiment, the second sub-pixel electrode 191b is connected from the fine branch portions to surround three sides of the first sub-pixel electrode 191a, and includes a connection portion 93 having a quadrangular semicircular shape. The connection portion 93 includes a first portion 93a formed in parallel with the gate lines 121, and two second portions 93b formed in parallel with the two data lines 171a and 171b. The first portion 93a and the two second portions 93b are interconnected to each other and surround three side boundaries of the first sub-pixel electrode 191a.

One of the fine branch portions of the first sub-pixel electrode 191a and the second sub-pixel electrode 191b obliquely extends in a left-upward direction from the horizontal stem portions or the vertical stem portions, and another fine branch portion obliquely extends in a right-upward direction from the horizontal stem portions or the vertical stem portions. Another fine branch portion extends in a left-downward direction from the horizontal stem portions or the vertical stem portions, and the remaining branch portion obliquely extends in a right-downward direction from the horizontal stem portions or the vertical stem portions.

Each of the fine branch portions makes an angle of about 45 or 135 degrees with the extending direction of the gate lines 121 or the horizontal stem portions. The branch portions in two adjacent sub-regions may extend perpendicular to each other.

Although not shown, the fine branch portions may become wider as they extend closer to the horizontal stem portions or the vertical stem portions.

The area occupied by the second sub-pixel electrode 191b in the entire pixel electrode 191 may be larger than the area occupied by the first sub-pixel electrode 191a, and the area of the second sub-pixel electrode 191b may be 1.0 to 2.5 times larger than that of the first sub-pixel electrode 191a. However, the shape or area ratio of the first and second sub-pixel electrodes 191a and 191b may be modified in various ways.

Referring still to FIG. 2, the first sub-pixel electrode 191a of the pixel electrode 191 is spaced apart from the gate lines 121 on a planar surface. A gap between the first sub-pixel electrode 191a and the gate lines 121 that are spaced apart may be about 2 μm to 7 μm. By spacing the first sub-pixel electrode 191a to which a high data voltage is applied apart from the gate lines 121, an unnecessary capacitance is avoided that otherwise may be formed between the first sub-pixel electrode 191a and the gate lines 121. This helps in reducing kickback voltage.

The first and second sub-pixel electrodes 191a and 191b are physically and electrically connected to the first and second drain electrodes 175a and 175b via contact holes 185a and 185b formed through the first passivation layer 180p, and are applied with respective data voltages from the corresponding ones of first and second drain electrodes 175a and 175b when their TFTs are switched on.

The planar patterns of the pixel electrodes 191 may be formed in various shapes. In the present exemplary embodiment, the pixel electrodes 191 include the first and second sub-pixel electrodes 191a and 191b, and the first and second sub-pixel electrodes 191a and 191b are connected to the first and second drain electrodes 175a and 175b, while in another exemplary embodiment, the pixel electrodes 191 may include one electrode and be connected to one drain electrode.

Next, details for the second display panel 200 of FIG. 3 will be described.

A first light blocking member 220 is formed on a provided second insulating substrate 210 made of transparent glass or plastic. The first light blocking member 220 is also called a black matrix, and blocks light leakage in areas where the liquid crystal orientation is not controlled by a respective pixel electrode.

The light blocking member 220 has a plurality of openings (not shown) that face the pixel electrodes 191 to allow the pixel electrode-controlled lights through and these openings have substantially the same shape as the pixel electrodes 191, where the remainder of the light blocking member 220 blocks light leakage in areas between the pixel electrodes 191. However, the light blocking member 220 may consist of portions corresponding to the gate lines 121 and the data lines 171 and portions corresponding to the thin film transistors for blocking leakage lights in those areas. As indicated above, in the case where the light blocking member 220 is disposed on the second display panel 200, it may be necessary to precisely align the pattern (openings) of the light blocking member 220 with counterpart features of the first display panel 100 when the first and second display panels, 100 and 200 are bonded to one another.

A planarizing overcoat layer 250 is formed on the first light blocking member 220. The overcoat 250 is made of an organic insulator and provides a flat surface. The overcoat 250 may be omitted.

The common electrode 270 is then formed on the overcoat 250 (or on the second display panel having the first light blocking member 220 already formed thereon if the overcoat 250 is omitted). The common electrode 270 is made of a transparent conductor such as indium tin oxide (ITO) or indium zinc oxide (IZO).

In the shown exemplary embodiment, the common electrode 270 is formed in the second display panel 200, however the present invention is not limited thereto, and in the case of a liquid crystal display according to another exemplary embodiment of the present invention, portions of the common electrode 270 that form electric fields in conjunction with corresponding pixel electrodes may be formed in the first display panel 100 where the latter includes a plurality of signal lines and a plurality of pixels PX connected thereto. Also, the second display panel 200 does not include thin film transistors (TFTs) of the pixel units.

Alignment layers (not shown) may be positioned on the first display panel 100 and the second display panel 200, and the alignment layers may be vertical alignment layers.

Polarizers (not shown) may be provided on outer surfaces of the lower thin film transistor display panel 100 and the upper common electrode display panel 200.

The liquid crystal layer 3 is interposed between the lower thin film transistor display panel and the upper common electrode display panel, and the liquid crystal layer 3 includes liquid crystal molecules (not shown) having negative dielectric anisotropy. The liquid crystal molecules of the liquid crystal layer 3 may have a pretilt angle so that their long axes are substantially parallel to the lengthwise direction of the fine branch portions of the first and second sub-pixel electrodes 191a and 191b, and they may be aligned so as to be perpendicular with respect to the surfaces of the two display panels 100 and 200. The liquid crystal layer 3 may further include an optical polymer, and this optical polymer enables the liquid crystal molecules to have a pretilt angle so that their long axes are substantially parallel to the lengthwise direction of the fine branch portions of the first and second sub-pixel electrodes 191a and 191b.

The first sub-pixel electrode 191a and the second sub-pixel electrode 191b are supplied with respective data voltages through their respective data lines 171a and 171b, where the voltage of the first sub-pixel electrode 191a having a relatively smaller area may be made higher than the voltage of the second sub-pixel electrode 191b having a relatively larger area.

In this way, when the voltages of the first sub-pixel electrode 191a and second sub-pixel electrode 191b are different from each other, the voltages applied to the liquid crystal capacitors Clca and Clcb formed in the two pixel electrodes 191a and 191b are different from each other, so the tilt angles of the liquid crystal molecules of each of the sub-pixels PXa and PXb are also different from each other. Therefore, the voltages supplied to these liquid crystal capacitors Clca and Clcb can be adjusted so that an image viewed from a lateral side is similar to an image viewed from a head on front viewing position, thereby improving the lateral image visibility for users positioned to the side of the display.

The backlight unit 300 is positioned outside (behind) the second display panel 200. First light L1 emitted from the backlight unit 300 may be collimated (or otherwise optically processed e.g., via a light guide plate) so as to be straightly propagated toward and incident upon the second display panel 200. Next, the amount of the first light L1 is controlled according to the arrangement of the liquid crystal molecules in the liquid crystal layer 3, and the light incident to the side of the first display panel 100 and passing through the first insulation substrate 110 is recognized by a user (not shown) disposed forward of the outer surface of the first display panel 100.

At this time, second lights L2 (e.g., ambient light) that is incident to the side of the first display panel 100 from the side of the user is blocked from being distractingly reflected by the reflective materials of the first display panel 100 because such second lights L2 are absorbed by the color filters 230A, 230B, and 230C and in particular by the overlapping sidewalls of the color filters where these overlapping sidewalls track the extension direction of the data lines and optionally also at other sidewalls thereof (not shown in FIG. 3) they track the extension direction of the gate lines. Reflection is minimized at the sidewalls of the color filter areas, for example where the first color filter 230A is overlapped by the second data line 171b and also by the second color filter 230B. Accordingly, by preventing reducing reflection of the light L2 inflowed to the thin film transistor array panel from the outside, the display image quality is improved due to the outside light being absorbed at least by the overlapped edges of adjacent color filters.

Also, the first light L1 incident from the backlight unit 300 is blocked by the first light blocking member 220 such that this L1 light is not incident to the protrusions 154a and 154b of the first semiconductor 151a and the second semiconductor 151b forming the channels of the first thin film transistor Qa and the second thin film transistor Qb. Accordingly, a leakage current of the channels according to incidence by the L1 light may be prevented.

Next, a liquid crystal display according to another exemplary embodiment of the present invention will be described with reference to FIG. 4 as well as FIG. 2. FIG. 4 is a cross-sectional view of a liquid crystal display according to another exemplary embodiment of the present invention taken along the line III-III of FIG. 2.

Referring to FIG. 4, the liquid crystal display according to the present exemplary embodiment is similar to the liquid crystal display of the exemplary embodiment of FIG. 2 and FIG. 3. A detailed description of like constituent elements will be omitted.

Referring to FIG. 4, the liquid crystal display the present exemplary embodiment includes the first display panel 100 and the second display panel 200 facing each other, the liquid crystal layer 3 interposed between the first display panel 100 and the second display panel 200, and the backlight unit 300 positioned outside the second display panel 200.

Firstly, the first display panel 100 will be described. A plurality of color filters 230A, 230B, and 230C are formed on the first insulation substrate 110. However, in a case of the liquid crystal display according to the present exemplary embodiment, differently from the liquid crystal display according to the exemplary embodiment of FIG. 3, the planarizing first insulating layer 180a is not positioned on the plurality of color filters 230A, 230B, and 230C. Instead, the gate lines 121 and storage electrode lines 131 are formed directly on the plurality of color filters 230A, 230B, and 230C, and then a gate insulating layer 140 is positioned thereon. The gate insulating layer 140 prevents the pigment of the plurality of color filters 230A, 230B, and 230C from being exposed and leaching out. The plurality of color filters 230A, 230B, and 230C are also protected by the gate insulating layer 140 from being lifted. Differently from this illustrated example, it is within the contemplation of the present disclosure to include the planarizing first insulating layer 180a.

A plurality of the first semiconductors 151a and the second semiconductors 151b are formed on the gate insulating layer 140, and ohmic contacts 161a, 161b, 163a, 163b, 165a, and 165b are formed thereon.

The first data line 171a and the second data line 171b, and the first drain electrode 175a and the second drain electrode 175b are formed on the ohmic contacts 161a, 161b, 163b, 163b, 165a, and 165b and the gate insulating layer 140.

A second passivation layer 180 made of a silicon nitride and/or a silicon oxide is formed on the data lines 171a and 171b, the drain electrodes 175a and 175b, and the exposed semiconductor islands 151a and 151b. A plurality of pixel electrodes 191 including the first sub-pixel electrode 191a and the second sub-pixel electrode 191b, and a connection portion 93 are formed on the second passivation layer 180.

In the embodiment of FIG. 4, the first light blocking member 220 is integrally formed on the first display panel 100 of the liquid crystal display. Therefore, according to this present exemplary embodiment, the second display panel 200 does not have any features that have to be precisely aligned with counterpart features provided on the first display panel 100. This can greatly simplify assembly of the first and second display panels, 100 and 200, one with the other.

The second display panel 200 will now be described. A common electrode 270 is formed on the second insulation substrate 210.

As described above, in the liquid crystal display according to the present exemplary embodiment, the first insulating layer 180a is not positioned on the plurality of color filters 230A, 230B, and 230C, and the gate insulating layer 140 prevents the pigment of the plurality of color filters 230A, 230B, and 230C from being exposed and the plurality of color filters 230A, 230B, and 230C from being lifted.

Also, the first light blocking member 220 is not positioned at the second display panel 200, but rather on the first display panel 100.

The backlight unit 300 is positioned outside the second display panel 200. The first light L1 emitted from the backlight unit 300 is substantially straightly propagated and is incident toward the second display panel 200. Next, the amount of the first light L1 is controlled according to the arrangement of the liquid crystal molecules in the liquid crystal layer 3, and the light incident to the side of the first display panel 100 and passing through the first insulation substrate 110 is recognized by the user.

At this time, the ambient second light L2 incident to the side of the first display panel 100 from the side of the user is absorbed by the color filters 230A, 230B, and 230C positioned on the first insulation substrate 110. Therefore ambient light reflection is not generated particularly at the color filter boundary areas where the tessellated color filters meet one another and at the same overlap the data lines, 171a-171b and/or the gate lines 121. Accordingly, by preventing the light inflowed to the thin film transistor array panel from the outside from being reflected by the signal lines such as the gate lines and the data lines, the display quality deterioration of the liquid crystal display due to glare from reflection of the outside ambient light may be prevented.

Also, the first light L1 incident from the backlight unit 300 is blocked by the first light blocking member 220 formed in the first display panel 100 such that the light is not incident to the protrusions 154a and 154b of the first semiconductor 151a and the second semiconductor 151b forming the channels of the first thin film transistor Qa and the second thin film transistor Qb. Accordingly, a leakage current of the channels according to the light may be prevented.

Many characteristics of the liquid crystal display according to the exemplary embodiment described with reference to FIG. 2 and FIG. 3 may be applied to the liquid crystal display of the present exemplary embodiment.

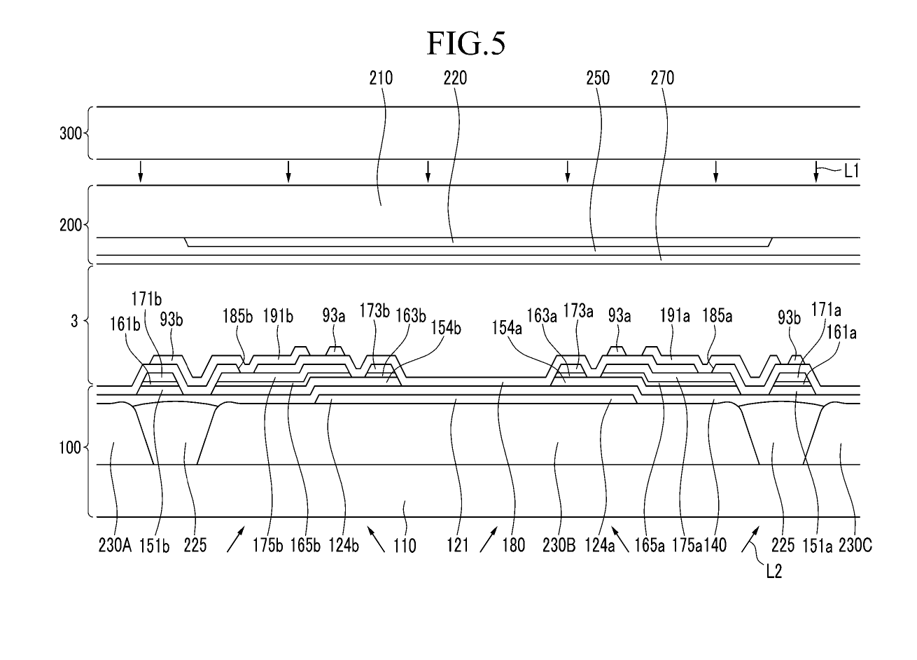

Next, a liquid crystal display according to yet another exemplary embodiment of the present invention will be described with reference to FIG. 5 as well as FIG. 2. FIG. 5 is a cross-sectional view of a liquid crystal display according to another exemplary embodiment of the present invention taken along the line III-III of FIG. 2.

Referring to FIG. 5, the liquid crystal display according to the present exemplary embodiment is similar in various respects to the liquid crystal display of the exemplary embodiment of FIG. 2 and FIG. 3 and to the liquid crystal display of the exemplary embodiment of FIG. 2 and FIG. 4. A detailed description of like constituent elements will thus be omitted.

Referring to FIG. 5, the liquid crystal display the present exemplary embodiment includes the first display panel 100 and the second display panel 200 facing each other, the liquid crystal layer 3 interposed between the first display panel 100 and the second display panel 200, and the backlight unit 300 positioned outside the second display panel 200.

Firstly, the first display panel 100 will be described. A plurality of differently colored color filters 230A, 230B, and 230C are formed on the first insulation substrate 110 for example in chess board type of matrix configuration. However, in a case of the liquid crystal display according to the present exemplary embodiment, differently from the liquid crystal display according to the exemplary embodiment of FIG. 3 and FIG. 4, the plurality of color filters 230A, 230B, and 230C are not positioned at the regions overlapped by the extensions of the first data line 171a and the second data line 171b. Instead, a second light blocking member 225 (e.g., a black colored, color filter) is positioned between the first and second color filters 230A, 230B where that area is overlapped by the second data line 171b and the second light blocking member 225 is further positioned between the second and third color filters, 230B-230C in the region overlapped by the first data line 171a.

Also, in the case of the liquid crystal display according to the present exemplary embodiment, the first insulating layer 180a is not formed on the plurality of color filters 230A, 230B, and 230C and on the second light blocking member 225. A gate line 121 and a storage electrode line 131 are formed on the plurality of color filters 230A, 230B, and 230C, and a gate insulating layer 140 is positioned thereon. The gate insulating layer 140 has a function of preventing the pigment of the plurality of color filters 230A, 230B, and 230C and the second light blocking member 225 from being exposed and the plurality of color filters 230A, 230B, and 230C and the second light blocking member 225 from being lifted.

A plurality of the first semiconductors 151a and the second semiconductors 151b are formed on the gate insulating layer 140, and ohmic contacts 161a, 161b, 163a, 163b, 165a, and 165b are formed thereon.

The first data line 171a and the second data line 171b, and the first drain electrode 175a and the second drain electrode 175b, are formed on the ohmic contacts 161a, 161b, 163a, 163b, 165a, and 165b and the gate insulating layer 140.

The second passivation layer 180 made of silicon nitride or silicon oxide is formed on the data lines 171a and 171b, the drain electrodes 175a and 175b, and the exposed semiconductors 151a and 151b. A plurality of pixel electrodes 191 including the first sub-pixel electrode 191a and the second sub-pixel electrode 191b, and a connection portion 93 are formed on the second passivation layer 180.

The second display panel 200 of FIG. 5 will now be described. The first light blocking member 220 is formed on the second insulation substrate 210, an overcoat 250 is formed on the first light blocking member 220, and a common electrode 270 is formed on the overcoat 250. The thin film transistors are not formed in the second display panel 200.

In the shown exemplary embodiment, the common electrode 270 is formed in the second display panel 200, however the present invention is not limited thereto, and in the case of a liquid crystal display according to another exemplary embodiment of the present invention, portions of the common electrode 270 may be formed in the first display panel 100 with the latter including a plurality of signal lines and a plurality of pixels PX connected thereto.

As described above, according to the liquid crystal display according to the present exemplary embodiment, the plurality of color filters 230A, 230B, and 230C are not positioned in the region overlapped by the first data line 171a and the second data line 171b, and instead the second light blocking member 225 is positioned between the first color filter 230A overlapping the second data line 171b and the second color filter 230B and between the second color filter 230B overlapping the first data line 171a and the third color filter 230C. Also, the first insulating layer 180a is not positioned on the plurality of color filters 230A, 230B, and 230C, and the gate insulating layer 140 has the function of preventing the pigment of the plurality of color filters 230A, 230B, and 230C from being exposed and the plurality of color filters 230A, 230B, and 230C from being lifted.

A backlight unit 300 is positioned outside the second display panel 200. The first light L1 emitted from the backlight unit 300 is about straightly propagated and is incident toward the second display panel 200. Next, the amount of the first light L1 is controlled according to the arrangement of the liquid crystal molecules in the liquid crystal layer 3, and the light incident to the side of the first display panel 100 and passing through the first insulation substrate 110 is recognized by the user.

At this time, the ambient second light L2 incident to the side of the first display panel 100 from the side of the user is absorbed by the color filters 230A, 230B, and 230C and the second light black matrix member 225 positioned on the first insulation substrate 110 such that the light is not reflected by the data line 171 and the gate line 121. Accordingly, by preventing the light inflowed to the thin film transistor array panel from the outside from being reflected by the signal lines such as the gate line and the data line formed in the thin film transistor array panel, the display quality deterioration of the liquid crystal display due to the outside light may be prevented.

Also, the first light L1 incident from the backlight unit 300 is blocked by the first light blocking member 220 such that the light is not incident to the protrusions 154a and 154b of the first semiconductor 151a and the second semiconductor 151b forming the channels of the first thin film transistor Qa and the second thin film transistor Qb. Accordingly, a leakage current of the channels according to the light may be prevented.

Many characteristics of the liquid crystal displays according to the exemplary embodiments described with reference to FIG. 2 and FIG. 3 and with reference to FIG. 2 and FIG. 4 may be applied to the liquid crystal display of the present exemplary embodiment.

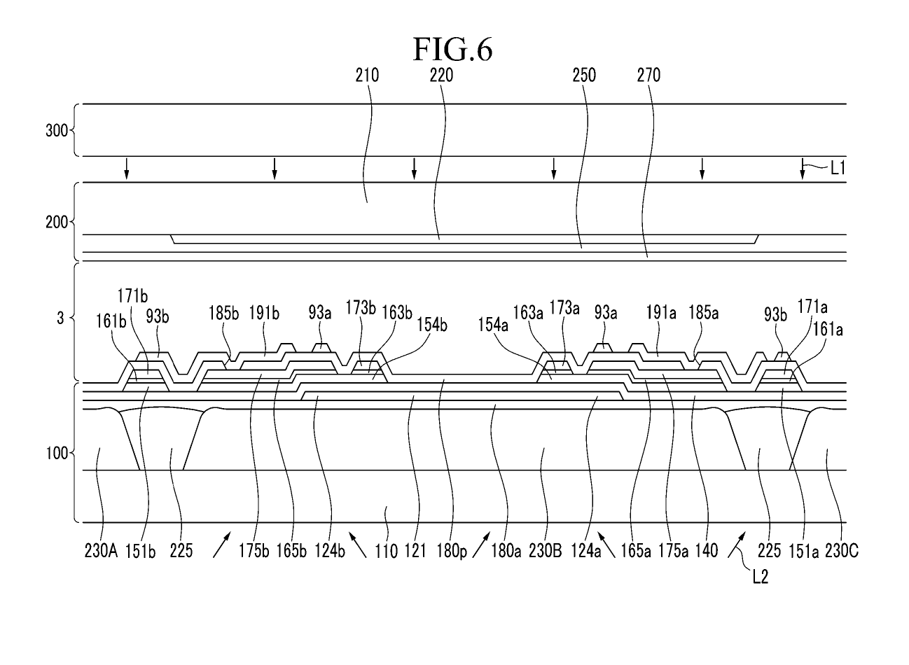

Next, a liquid crystal display according to another exemplary embodiment of the present disclosure of invention will be described with reference to FIG. 6 as well as FIG. 2. FIG. 6 is a cross-sectional view of a liquid crystal display according to another exemplary embodiment taken along the line III-III of FIG. 2.

Referring to FIG. 6, the liquid crystal display according to the present exemplary embodiment is similar to the liquid crystal display of the exemplary embodiment of FIG. 2 and FIG. 3, the liquid crystal display of the exemplary embodiment of FIG. 2 and FIG. 4, and the liquid crystal display of the exemplary embodiment of FIG. 2 and FIG. 5. A detailed description of like constituent elements will be omitted.

Referring to FIG. 6, the liquid crystal display the present exemplary embodiment includes the first display panel 100 and the second display panel 200 facing each other, the liquid crystal layer 3 interposed between the first display panel 100 and the second display panel 200, and the backlight unit 300 positioned outside the second display panel 200.

Firstly, the first display panel 100 will be described.

A plurality of color filters 230A, 230B, and 230C are formed on the first insulation substrate 110. However, in a case of the liquid crystal display according to the present exemplary embodiment, differently from the liquid crystal display according to the exemplary embodiment of FIG. 3 and FIG. 4, the plurality of color filters 230A, 230B, and 230C are not positioned at the region overlapped by the first data line 171a and the second data line 171b. Instead the second light blocking member 225 (e.g., black colored color filter material) is positioned between the first color filter 230A overlapping the second data line 171b and the second color filter 230B and between the second color filter 230B overlapping the first data line 171a and the third color filter 230C.

Also, in the case of the liquid crystal display according to the present exemplary embodiment, the first insulating layer 180a is formed on the plurality of color filters 230A, 230B, and 230C and the second light blocking member 225. The first insulating layer 180a prevents leaching of pigments from the plurality of color filters 230A, 230B, and 230C and the second light blocking member 225 due to the latter being exposed and the plurality of color filters 230A, 230B, and 230C and the second light blocking member 225 from being lifted, and removes a difference of heights of the plurality of color filters 230A, 230B, and 230C and the second light blocking member 225, thereby providing flatness. The first insulating layer 180a may include an inorganic insulator or an organic insulator.

A gate line 121 and a storage electrode line 131 are formed on the first insulating layer 180a, and a gate insulating layer 140 is positioned thereon. A plurality of the first semiconductors 151a and the second semiconductors 151b are formed on the gate insulating layer 140, and ohmic contacts 161a, 161b, 163a, 163b, 165a, and 165b are formed thereon.

The first data line 171a and the second data line 171b, and the first drain electrode 175a and the second drain electrode 175b, are formed on the ohmic contacts 161a, 161b, 163a, 163b, 165a, and 165b and the gate insulating layer 140.

The second passivation layer 180 made of a silicon nitride and/or a silicon oxide is formed on the data lines 171a and 171b, the drain electrodes 175a and 175b, and the exposed semiconductors 151a and 151b. A plurality of pixel electrodes 191 including the first sub-pixel electrode 191a and the second sub-pixel electrode 191b, and a connection portion 93 are formed on the second passivation layer 180.

The second display panel 200 will now be described. The first light blocking member 220 is positioned on the second insulation substrate 210, an overcoat 250 is formed on the first light blocking member 220, and a common electrode 270 is formed on the overcoat 250. The second display panel 200 does not include the thin film transistor.

In the exemplary embodiment, the common electrode 270 is formed in the second display panel 200, however the present invention is not limited thereto, and in a case of a liquid crystal display according to another exemplary embodiment of the present invention, the common electrode 270 may be formed in the first display panel 100 including a plurality of signal lines and a plurality of pixels PX connected thereto.

As described above, according to the liquid crystal display according to the present exemplary embodiment (FIG. 6), a plurality of color filters 230A, 230B, and 230C are not positioned in the region overlapped by the first data line 171a and the second data line 171b, and instead the substantially more absorbing second light blocking member 225 is positioned between the first color filter 230A overlapping the second data line 171b and the second color filter 230B and between the second color filter 230B overlapping the first data line 171a and the third color filter 230C.

A backlight unit 300 is positioned outside the second display panel 200. The first light L1 emitted from the backlight unit 300 is about straightly propagated and is incident toward the second display panel 200. Next, the amount of the first light L1 is controlled according to the arrangement of the liquid crystal molecules in the liquid crystal layer 3, and the light incident to the side of the first display panel 100 and passing through the first insulation substrate 110 is recognized by the user.

At this time, the ambient second light L2 incident (e.g., as glare) to the side of the first display panel 100 from the side of the user is absorbed by the color filters 230A, 230B, and 230C and the second light black matrix member 225 positioned on the first insulation substrate 110 such that the light is not reflected by the data lines 171 and the gate lines 121. Accordingly, by preventing the light inflowed to the thin film transistor array panel from the outside from being reflected by the signal lines such as the gate line and the data line formed in thin film transistor array panel, the display quality deterioration of the liquid crystal display due to the outside light may be prevented.

Also, the first light L1 incident from the backlight unit 300 is blocked by the first light blocking member 220 such that the light is not incident to the protrusions 154a and 154b of the first semiconductor 151a and the second semiconductor 151b forming the channels of the first thin film transistor Qa and the second thin film transistor Qb. Accordingly, a leakage current of the channels according to the light may be prevented.

Many characteristics of the liquid crystal displays according to the exemplary embodiments described with reference to FIG. 2 and FIG. 3, FIG. 2 and FIG. 4, and FIG. 2 and FIG. 5 may be applied to the liquid crystal display of the present exemplary embodiment

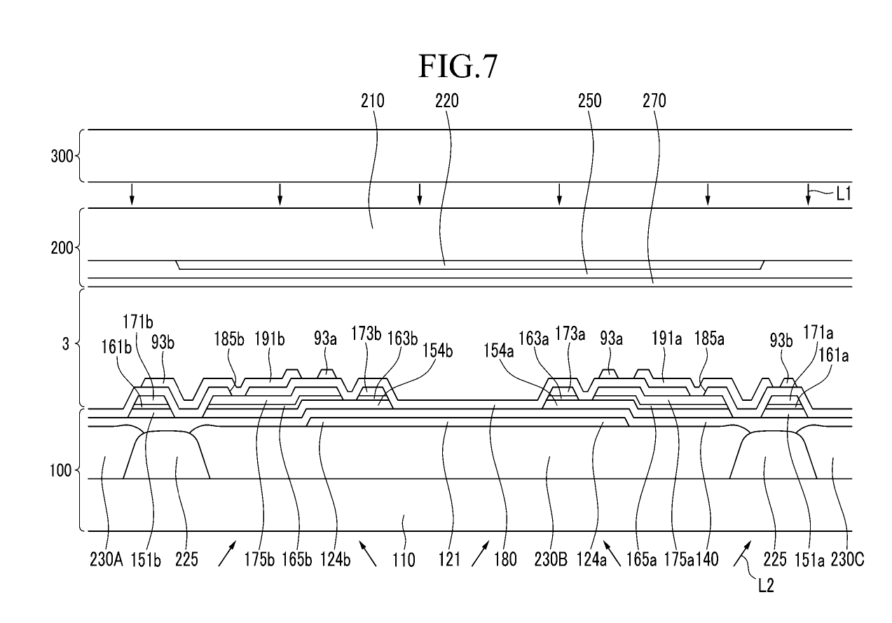

Next, a liquid crystal display according to yet another exemplary embodiment of the present invention will be described with reference to FIG. 7 as well as FIG. 2. FIG. 7 is a cross-sectional view of a liquid crystal display according to another exemplary embodiment of the present invention taken along the line III-III of FIG. 2.

Referring to FIG. 7, the liquid crystal display according to the present exemplary embodiment is similar to the liquid crystal displays according to the exemplary embodiments described with reference to FIG. 2 and FIG. 3, FIG. 2 and FIG. 4, FIG. 2 and FIG. 5, and FIG. 2 and FIG. 6. A detailed description of like constituent elements will be omitted.

Referring to FIG. 7, the liquid crystal display the present exemplary embodiment includes the first display panel 100 and the second display panel 200 facing each other, the liquid crystal layer 3 interposed between the first display panel 100 and the second display panel 200, and the backlight unit 300 positioned outside the second display panel 200.

The first display panel 100 will now be described.

In a case of the liquid crystal display according to the present exemplary embodiment, differently from the liquid crystal display according to the previous exemplary embodiments, the second light blocking member 225 is formed on the first insulation substrate 110 firstly as lines having noninverted frusto-pyramid shapes in their cross sections (as opposed to the inverted pyramid shapes of FIG. 6 for example). The second light blocking member 225 is disposed at the position overlapping the first data line 171a and the second data line 171b. A plurality of color filters 230A, 230B, and 230C are then formed in the open wells defined by the firstly-formed second light blocking member 225 and on the first insulation substrate 110. Also, in the case of the liquid crystal display according to the present exemplary embodiment, differently from the liquid crystal display according to the exemplary embodiment shown in FIG. 3 and FIG. 4, the plurality of color filters 230A, 230B, and 230C are not positioned on the region overlapped by the first data line 171a and the second data line 171b.

Further, in the case of the liquid crystal display according to the present exemplary embodiment, the first insulating layer 180a is not positioned on the second light blocking member 225 and the plurality of color filters 230A, 230B, and 230C. A gate line 121 and a storage electrode line 131 are formed on the second light blocking member 225 and the plurality of color filters 230A, 230B, and 230C, and a gate insulating layer 140 is positioned thereon. The gate insulating layer 140 prevents the pigment of the second light blocking member 225 and the plurality of color filters 230A, 230B, and 230C from being exposed, and the second light blocking member 225 and the plurality of color filters 230A, 230B, and 230C from being lifted.

A plurality of the first semiconductors 151a and the second semiconductors 151b are formed on the gate insulating layer 140, and ohmic contacts 161a, 161b, 163a, 163b, 165a, and 165b are formed thereon.

The first data line 171a and the second data line 171b, and the first drain electrode 175a and the second drain electrode 175b, are formed on the ohmic contacts 161a, 161b, 163a, 163b, 165a, and 165b and the gate insulating layer 140.

The second passivation layer 180 made of a silicon nitride and/or a silicon oxide is formed on the data lines 171a and 171b, the drain electrodes 175a and 175b, and the exposed semiconductors 151a and 151b. A plurality of pixel electrodes 191 including the first sub-pixel electrode 191a and the second sub-pixel electrode 191b, and a connection portion 93 are formed on the second passivation layer 180.

The second display panel 200 of FIG. 7 will now be described. The first light blocking member 220 is formed on the second insulation substrate 210, an overcoat 250 is formed on the first light blocking member 220, and a common electrode 270 is formed on the overcoat 250. The thin film transistor is not formed in the second display panel 200.

In the shown exemplary embodiment, the common electrode 270 is formed in the second display panel 200, however the present invention is not limited thereto, and in the case of the liquid crystal display according to another exemplary embodiment of the present invention, the common electrode 270 may be formed in the first display panel 100 including a plurality of signal lines and a plurality of pixels PX connected thereto.

As described above, according to the liquid crystal display according to the present exemplary embodiment, the second light blocking member 225 is positioned on the first insulation substrate 110. The second light blocking member 225 is formed at the position overlapping the first data line 171a and the second data line 171b. The plurality of color filters 230A, 230B, and 230C are formed on the second light blocking member 225 and the first insulation substrate 110. That is, the plurality of color filters 230A, 230B, and 230C are not positioned at the region overlapping the first data line 171a and the second data line 171b. Also, the first insulating layer 180a is positioned on the plurality of color filters 230A, 230B, and 230C, and the gate insulating layer 140 has the function of preventing the pigment of the plurality of color filters 230A, 230B, and 230C from being exposed and the plurality of color filters 230A, 230B, and 230C from being lifted.

A backlight unit 300 is positioned outside the second display panel 200. The first light L1 emitted from the backlight unit 300 is about straightly propagated and is incident toward the second display panel 200. Next, the amount of the first light L1 is controlled according to the arrangement of the liquid crystal molecules in the liquid crystal layer 3, and the light incident to the side of the first display panel 100 and passing through the first insulation substrate 110 is recognized by the user.

At this time, the ambient second light L2 (e.g., glare) incident to the side of the first display panel 100 from the side of the user is absorbed by the color filters 230A, 230B, and 230C and the second light blocking member 225 positioned on the first insulation substrate 110 such that the light is not reflected by the data line 171 and the gate line 121. Accordingly, by preventing the light inflowed to the thin film transistor array panel from the outside from being reflected by the signal lines such as the gate line and the data line formed in the thin film transistor array panel, the display quality deterioration of the liquid crystal display due to the outside light may be prevented.

Also, the first light L1 incident from the backlight unit 300 is blocked by the first light blocking member 220 such that the light is not incident to the protrusions 154a and 154b of the first semiconductor 151a and the second semiconductor 151b forming the channels of the first thin film transistor Qa and the second thin film transistor Qb. Accordingly, a leakage current of the channels according to the light may be prevented.

Many characteristics of the liquid crystal displays according to the exemplary embodiments described with reference to FIG. 2 and FIG. 3, FIG. 2 and FIG. 4, FIG. 2 and FIG. 5, and FIG. 2 and FIG. 6 may be applied to the liquid crystal display of the present exemplary embodiment.

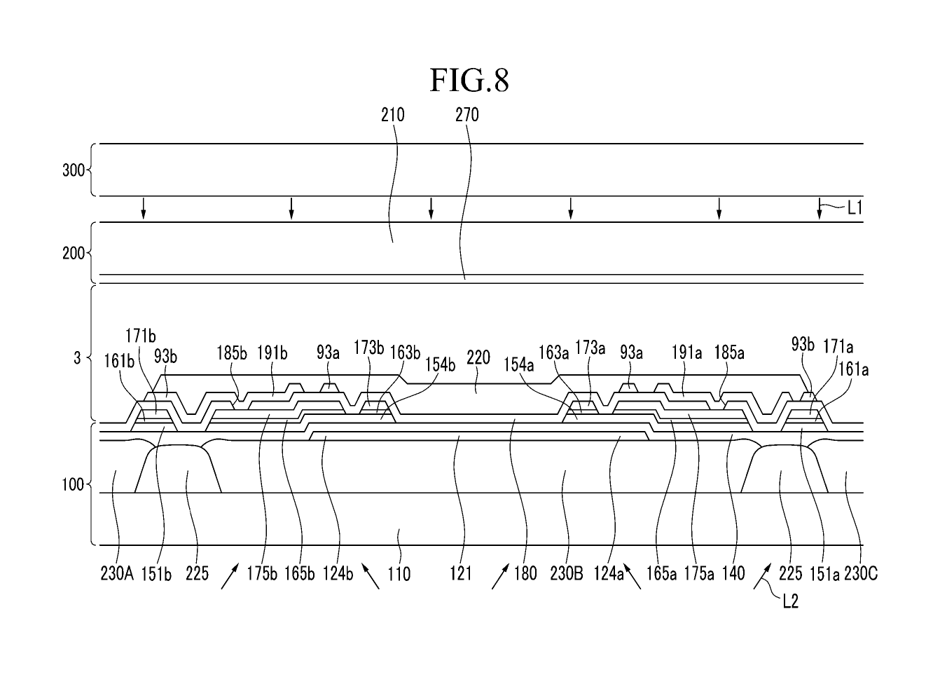

Next, a liquid crystal display according to another exemplary embodiment of the present invention will be described with reference to FIG. 8 as well as FIG. 2. FIG. 8 is a cross-sectional view of a liquid crystal display according to another exemplary embodiment of the present invention taken along the line III-III of FIG. 2.

Referring to FIG. 8, the liquid crystal display according to the present exemplary embodiment is similar to the liquid crystal display of the exemplary embodiment of FIG. 2 and FIG. 3, FIG. 2 and FIG. 4, FIG. 2 and FIG. 5, FIG. 2 and FIG. 6, and FIG. 2 and FIG. 7.

A detailed description of like constituent elements will be omitted.

Referring to FIG. 8, the liquid crystal display the present exemplary embodiment includes the first display panel 100 and the second display panel 200 facing each other, the liquid crystal layer 3 interposed between the first display panel 100 and the second display panel 200, and the backlight unit 300 positioned outside the second display panel 200.

The first display panel 100 will now be described.

In the case of the liquid crystal display according to the present exemplary embodiment, like the exemplary embodiment shown in FIG. 7, the second light blocking member 225 (having lines of noninverted fursto-pyramid cross sections) is firstly formed on the first insulation substrate 110. The light blocking portions of the second light blocking member 225 are disposed at the positions overlapped by the first data line 171a and the second data line 171b. A plurality of color filters 230A, 230B, and 230C are thereafter formed by deposition into the open wells of the second light blocking member 225 and onto the first insulation substrate 110. Also, in the case of the liquid crystal display according to the present exemplary embodiment, differently from the liquid crystal display according to the exemplary embodiment of FIG. 3 and FIG. 4, the plurality of color filters 230A, 230B, and 230C are not positioned at the region overlapping the first data line 171a and the second data line 171b.

Also, in the case of the liquid crystal display according to the present exemplary embodiment, the first insulating layer 180a is not positioned on the second light blocking member 225 and the plurality of color filters 230A, 230B, and 230C. A gate line 121 and a storage electrode line 131 are formed on the second light blocking member 225 and the plurality of color filters 230A, 230B, and 230C, and a gate insulating layer 140 is positioned thereon. The gate insulating layer 140 prevents the pigment of the second light blocking member 225 and the plurality of color filters 230A, 230B, and 230C from being exposed and the second light blocking member 225 and the plurality of color filters 230A, 230B, and 230C from being lifted.

A plurality of the first semiconductors 151a and the second semiconductors 151b are formed on the gate insulating layer 140, and ohmic contacts 161a, 161b, 163a, 163b, 165a, and 165b are formed thereon.

The first data line 171a and the second data line 171b, and the first drain electrode 175a and the second drain electrode 175b, are formed on the ohmic contacts 161a, 161b, 163a, 163b, 165a, and 165b and the gate insulating layer 140.

The second passivation layer 180 made of a silicon nitride and/or a silicon oxide is formed on the data lines 171a and 171b, the drain electrodes 175a and 175b, and the exposed semiconductors 151a and 151b. A plurality of pixel electrodes 191 including the first sub-pixel electrode 191a and the second sub-pixel electrode 191b, and a connection portion 93 are formed on the second passivation layer 180.

Also, the first light blocking member 220 is not positioned in the second display panel 200, but rather in the first display panel 100.

The second display panel 200 will now be described. A common electrode 270 is formed on the second insulation substrate 210. The second display panel 200 does not include the thin film transistor.

In the shown exemplary embodiment, the common electrode 270 is formed in the second display panel 200, however the present invention is not limited thereto, and in the case of the liquid crystal display according to another exemplary embodiment of the present invention, the common electrode 270 may be formed in the first display panel 100 including a plurality of signal lines and a plurality of pixels PX connected thereto.

A backlight unit 300 is positioned outside the second display panel 200. The first light L1 emitted from the backlight unit 300 is about straightly propagated and is incident toward the second display panel 200. Next, the amount of the first light L1 is controlled according to the arrangement of the liquid crystal molecules in the liquid crystal layer 3, and the light incident to the side of the first display panel 100 and passing through the first insulation substrate 110 is recognized by the user.

At this time, the second light L2 incident to the side of the first display panel 100 from the side of the user is absorbed by the color filters 230A, 230B, and 230C, and the plurality of color filters 230A, 230B, and 230C are not positioned on the region overlapping the first data line 171a and the second data line 171b. The reflection is not generated between the first color filter 230A overlapping the second data line 171b and the second color filter 230B, because of the second gate line 121 overlapping the first data line 171a and the data line 171. Accordingly, by preventing the light inflowed to the thin film transistor array panel from the outside from being reflected by the signal lines such as the gate line and the data line formed in thin film transistor array panel, the display quality deterioration of the liquid crystal display due to the outside light may be prevented.

Also, the first light L1 incident from the backlight unit 300 is blocked by the first light blocking member 220 formed in the first display panel 100 such that the light is not incident to the protrusions 154a and 154b of the first semiconductor 151a and the second semiconductor 151b forming the channels of the first thin film transistor Qa and the second thin film transistor Qb. Accordingly, a leakage current of the channels according to the light may be prevented.

Many characteristics of the liquid crystal displays according to the exemplary embodiments described with reference to FIG. 2 and FIG. 3, FIG. 2 and FIG. 4, FIG. 2 and FIG. 5, FIG. 2 and FIG. 6, and FIG. 2 and FIG. 7 may be applied to the liquid crystal display of the present exemplary embodiment.

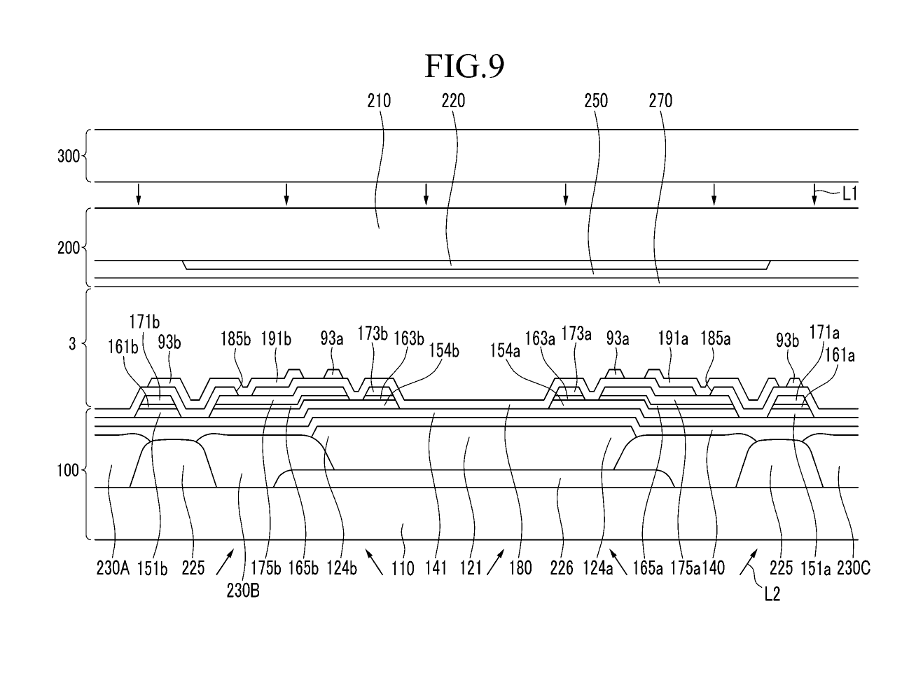

Next, a liquid crystal display according to another exemplary embodiment of the present invention will be described with reference to FIG. 9 as well as FIG. 2. FIG. 9 is a cross-sectional view of a liquid crystal display according to another exemplary embodiment of the present invention taken along the line III-III of FIG. 2.

Referring to FIG. 9, the liquid crystal display according to the present exemplary embodiment is similar to the liquid crystal displays of the exemplary embodiments described with reference to FIG. 2 and FIG. 3, FIG. 2 and FIG. 4, FIG. 2 and FIG. 5, FIG. 2 and FIG. 6, FIG. 2 and FIG. 7, and FIG. 2 and FIG. 8. A detailed description of like constituent elements will be omitted.

Referring to FIG. 9, the liquid crystal display the present exemplary embodiment includes the first display panel 100 and the second display panel 200 spaced apart from and facing each other, the liquid crystal layer 3 interposed between the first display panel 100 and the second display panel 200, and the backlight unit 300 positioned behind (or “below” if using the alternate frame of reference) the second display panel 200.

Firstly, the first display panel 100 will be described.

In the case of the liquid crystal display according to the present exemplary embodiment, like the exemplary embodiment shown in FIG. 7, the second light blocking member 225 is formed on the first insulation substrate 110. The second light blocking member 225 is disposed at the positions overlapped by the first data line 171a and the second data line 171b. Therefore, the second light blocking member 225 operates to prevent or substantially reduce reflection of ambient outside light (L2) from the data lines 171a/b and back towards a user such that it appears as undesired glare or other such visual artifacts. Also in the cross section illustrated by FIG. 9, a third light blocking member 226 is shown as being positioned on the first insulation substrate 110 and disposed under and extending along the longitudinal direction of the gate line 121. Therefore, the third light blocking member 226 operates to prevent or substantially reduce reflection of ambient outside light (L2) from the gate lines 121 and back towards a user such that it appears as undesired glare or other such visual artifacts. The third light blocking member 226 further overlaps with the protrusions of 154a and 154b of the first semiconductive island 151a and of the second semiconductive island 151b which form the channels of the respective thin film transistors. Therefore, these are prevented from being struck undesirably by ambient light L2. Also, the color filters 230A, 230B, and 230C are not positioned at the region where the gate line 121 is positioned to underlie the respective transistor channel regions and thus direct upward leaching of color filter pigment chemicals from underlying color filters is inhibited to a greater degree than in cases where one or more color filters do underlie the channel regions. To compensate for the missing thickness of the color filters in that area and in accordance with one embodiment, the gate line 121 is more thickly formed. By forming the thicker gate line 121, its electrical resistance is lowered and the gate signal of the high resolution liquid crystal display may be transmitted without as large a signal delay as otherwise might be present (a lower RC delay factor). It is within the contemplation of the disclosure to alternatively use other ways to cause the top surface of the gate line (“top” is as shown in FIG. 9) to protrude above the top surfaces of the adjacent color filter portions (e.g., 230B) for example by thickening with an appropriate inorganic or organic insulator.

Also, in the case of the liquid crystal display according to the present exemplary embodiment, the first insulating layer 180a is not positioned on the second light blocking member 225 and the plurality of color filters 230A, 230B, and 230C. A gate insulating layer 140 is positioned on the second light blocking member 225, the plurality of color filters 230A, 230B, and 230C, and gate line 121. The gate insulating layer 140 prevents the pigment of the second light blocking member 225 and the plurality of color filters 230A, 230B, and 230C from being exposed and prevents the second light blocking member 225 and the plurality of color filters 230A, 230B, and 230C from being lifted.

A second insulating layer 141 is positioned on the gate insulating layer 140. The second insulating layer 141 may include the inorganic insulating layer or the organic insulator, or it may be omitted. In the case where the second insulating layer 141 is included, at least one of layers 141 and 140 preferably functions as dielectric layer of high dielectric constant (e.g., a SiN layer) and the other preferably functions as dielectric layer of high voltage breakdown character (e.g., a SiO layer).

A plurality of the first semiconductive islands 151a and the second semiconductive islands 151b are formed on the second insulating layer 141, and the ohmic contacts 161a, 161b, 163a, 163b, 165a, and 165b are formed thereon.

The first data line 171a and the second data line 171b, and the first drain electrode 175a and the second drain electrode 175b, are formed on the ohmic contacts 161a, 161b, 163a, 163b, 165a, and 165b and the second gate insulating layer 141.

The second passivation layer 180 made of silicon nitride or silicon oxide is formed on the data lines 171a and 171b, the drain electrodes 175a and 175b, and the exposed semiconductive islands 151a and 151b. A plurality of pixel electrodes 191 including the first sub-pixel electrode 191a and the second sub-pixel electrode 191b, and a connection portion 93 are formed on the second passivation layer 180.

The second display panel 200 of FIG. 9 will now be described. The first light blocking member 220 is formed on the second insulation substrate 210, an overcoat 250 is formed on the first light blocking member 220, and a common electrode 270 is formed on the overcoat 250. The thin film transistors are not formed in the second display panel 200.

In the shown exemplary embodiment, the common electrode 270 is formed in the second display panel 200, however the present disclosure of invention is not limited thereto, and in the case of the liquid crystal display according to another exemplary embodiment of the present teachings, portions of the common electrode 270 may be instead formed in the first display panel 100 including a plurality of signal lines and a plurality of pixels PX connected thereto.

As described above, in to the liquid crystal display according to the present exemplary embodiment, the second light blocking member 225 is positioned on the first insulation substrate 110. The second light blocking member 225 is formed at the position overlapped by the first data line 171a and the second data line 171b. Also, the third light blocking member 226 is formed on the first insulation substrate 110. The third light blocking member 226 is disposed on the position overlapped by the gate line 121 and the protrusions of 154a and 154b of the first semiconductor 151a and the second semiconductor 151b forming the channels of the thin film transistors. Also, each of the color filters 230A, 230B, and 230C are removed on the region where the gate line 121 is positioned. Accordingly, the gate line 121 may be more thickly formed. By forming the thicker gate line 121, its electrical resistance is reduced and the gate signal of the high resolution liquid crystal display may be transmitted without a significant signal delay.

Also, the first insulating layer 180a is not positioned on the second light blocking member 225 and the plurality of color filters 230A, 230B, and 230C, and the dual gate insulating layers 140, 141 prevent the pigment of a plurality of color filters 230A, 230B, and 230C from being exposed and a plurality of color filters 230A, 230B, and 230C from being lifted

A backlight unit 300 is positioned outside the second display panel 200. The first light L1 emitted from the backlight unit 300 is generally straightly propagated toward and is incident upon the second display panel 200. The amount of the first light L1 passed through is controlled according to the arrangement of the liquid crystal molecules in the liquid crystal layer 3, and the light incident to the side of the first display panel 100 and passing through the first insulation substrate 110 is recognized by the user.

At this time, the ambient second light L2 which may be incident to the side of the first display panel 100 from the side of the user is absorbed by the color filters 230A, 230B, and 230C, is absorbed by the second light blocking member 225, and is absorbed by the third light blocking member 226 positioned on the first insulation substrate 110 such that the outside light (L2) is not reflected by the gate lines 121 and the data lines 171 back to the user. Accordingly, by preventing the light inflowed to the thin film transistor array panel from the outside from being reflected by the signal lines such as the gate lines and the data lines formed in a thin film transistor array panel, the display quality deterioration of the liquid crystal display due to the outside light may be prevented.

Also, the first light L1 incident from the backlight unit 300 is blocked by the first light blocking member 220 such that the light is not incident to the protrusions 154a and 154b of the first semiconductor 151a and the second semiconductor 151b forming the channels of the first thin film transistor Qa and the second thin film transistor Qb. Accordingly, a leakage current of the channels according to the light L1 may be prevented.

Many characteristics of the liquid crystal displays according to the exemplary embodiments described with reference to FIG. 2 and FIG. 3, FIG. 2 and FIG. 4, FIG. 2 and FIG. 5, FIG. 2 and FIG. 6, FIG. 2 and FIG. 7, and FIG. 2 and FIG. 8 may be applied to the liquid crystal display of the present exemplary embodiment.

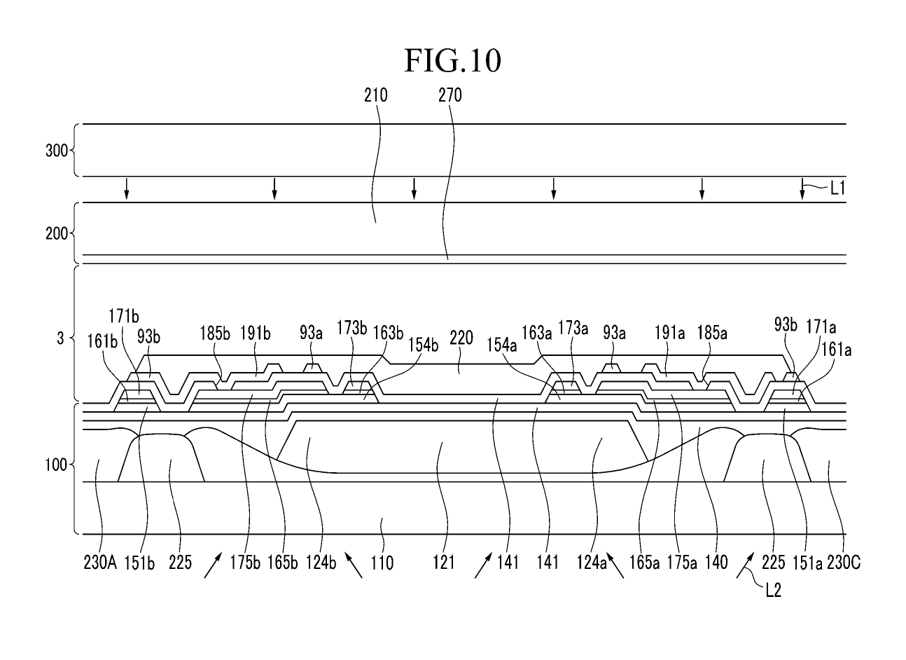

Next, a liquid crystal display according to another exemplary embodiment of the present invention will be described with reference to FIG. 10 as well as FIG. 2. FIG. 10 is a cross-sectional view of a liquid crystal display according to another exemplary embodiment of the present disclosure taken along the line III-III of FIG. 2.

Referring to FIG. 10, the liquid crystal display according to the present exemplary embodiment is similar to the liquid crystal displays of the exemplary embodiments described with reference to FIG. 2 and FIG. 3, FIG. 2 and FIG. 4, FIG. 2 and FIG. 5, FIG. 2 and FIG. 6, FIG. 2 and FIG. 7, FIG. 2 and FIG. 8, and FIG. 2 and FIG. 9. A detailed description of like constituent elements will be omitted.

Referring to FIG. 10, the liquid crystal display the present exemplary embodiment includes the first display panel 100 and the second display panel 200 facing each other, the liquid crystal layer 3 interposed between the first display panel 100 and the second display panel 200, and the backlight unit 300 positioned outside (behind) the second display panel 200.

The first display panel 100 will be described.

In the case of the liquid crystal display according to the present exemplary embodiment, similar to the exemplary embodiment shown in FIG. 7, the second light blocking member 225 is formed on the first insulation substrate 110. The second light blocking member 225 is disposed at positions overlapped by the first data line 171a and by the second data line 171b. A plurality of color filters 230A, 230B, and 230C are formed adjacent to (e.g., deposited afterward and thus on) the second light blocking member 225 and on the first insulation substrate 110. The color filters 230A, 230B, and 230C are formed with a lower top surface height than that of the adjacent gate line 121 in the region where the gate line 121 is positioned. The gate line 121 may be thickly formed as in the previously described case and disposed on top of a curved third light blocking member 226 positioned on the first insulation substrate 110 as shown in FIG. 10. By forming the thicker gate line 121, its resistance is reduced and the gate signal of the high resolution liquid crystal display may be transmitted without a significant signal delay.

Also, in the case of the liquid crystal display according to the present exemplary embodiment of FIG. 10, the first insulating layer 180a is not positioned on the second light blocking member 225 and on the plurality of color filters 230A, 230B, and 230C. Instead, a thicker first gate insulating layer 140 is positioned on the second light blocking member 225, on the plurality of color filters 230A, 230B, and 230C, and on the gate line 121. The first gate insulating layer 140 prevents the pigment of the second light blocking member 225 and the plurality of color filters 230A, 230B, and 230C from being exposed, and the second light blocking member 225 and the plurality of color filters 230A, 230B, and 230C from being lifted.

The second gate insulating layer 141 is positioned on the first gate insulating layer 140. The second gate insulating layer 141 may include the inorganic insulating layer or the organic insulator, or may be omitted.

A plurality of the first semiconductors 151a and the second semiconductors 151b are formed on the second gate insulating layer 141, and the ohmic contacts 161a, 161b, 163a, 163b, 165a, and 165b are formed thereon.

The first data line 171a and the second data line 171b, and the first drain electrode 175a and the second drain electrode 175b, are formed on the ohmic contacts 161a, 161b, 163a, 163b, 165a, and 165b, and the gate insulating layer 140.

The second passivation layer 180 [[MISLABELED IN FIG. 10 ]] made of silicon nitride or silicon oxide is formed on the data lines 171a and 171b, the drain electrodes 175a and 175b, and the exposed semiconductors 151a and 151b. A plurality of pixel electrodes 191 including the first sub-pixel electrode 191a and the second sub-pixel electrode 191b, and a connection portion 93 are formed on the second passivation layer 180.

Also, in the case of FIG. 10, the first light blocking member 220 is not positioned in the second display panel 200, but rather in the first display panel 100 as shown.

The second display panel 200 will now be described. A common electrode 270 is formed on the second insulation substrate 210. The thin film transistor is not formed in the second display panel 200.

In the shown exemplary embodiment, the common electrode 270 is formed in the second display panel 200, however the present disclosure of invention is not limited thereto, and in the case of the liquid crystal display according to another exemplary embodiment of the present teachings, portions of the common electrode 270 may be formed in the first display panel 100 including a plurality of signal lines and a plurality of pixels PX connected thereto.

As described above, according to the liquid crystal display according to the present exemplary embodiment, the second light blocking member 225 is positioned on the first insulation substrate 110. The second light blocking member 225 is formed at the positions overlapped by the first data line 171a and by the second data line 171b. Also, the third light blocking member 226 is formed on the first insulation substrate 110 to extend in thinned form under the thickened gate electrode 121. Further, each of the color filters 230A, 230B, and 230C is formed with a low height in the region where the gate line 121 is positioned. Accordingly, the gate line 121 may be thickly formed to reduce its electrical resistance. By forming the thick gate line 121, a gate signal of a high resolution liquid crystal display may be transmitted without a signal delay.

Also, the first insulating layer 180a is not positioned on the second light blocking member 225 and the plurality of color filters 230A, 230B, and 230C, and the gate insulating layer 140 prevents the pigment of the plurality of color filters 230A, 230B, and 230C from being exposed and the plurality of color filters 230A, 230B, and 230C from being lifted.

A backlight unit 300 is positioned outside (behind) the second display panel 200. The first light L1 emitted from the backlight unit 300 is generally straightly propagated toward and is incident upon the second display panel 200. Next, the amount of the first light L1 is controlled according to the arrangement of the liquid crystal molecules in the liquid crystal layer 3 and the light incident to the side of the first display panel 100 and passing through the first insulation substrate 110 is recognized by the user.

At this time, the ambient second light L2 incident to the side of the first display panel 100 from the side of the user is absorbed by the color filters 230A, 230B, and 230C and by the second light blocking member 225 positioned on the first insulation substrate 110 such that the light is not reflected by the gate lines 121 and by the data lines 171 back to the user (not shown). By preventing the light (e.g., L2) inflowed to the thin film transistor array panel from the outside from being reflected by the signal lines such as the gate line and the data line formed in the thin film transistor array panel, the display quality deterioration of the liquid crystal display due to the outside light may be prevented.

Also, the first light L1 incident from the backlight unit 300 is blocked by the first light blocking member 220 such that the light is not incident to the protrusions 154a and 154b of the first semiconductor 151a and the second semiconductor 151b forming the channels of the first thin film transistor Qa and the second thin film transistor Qb. Accordingly, a leakage current of the channels according to the light may be prevented.

Many characteristics of the liquid crystal display according to the exemplary embodiments described with reference to FIG. 2 and FIG. 3, FIG. 2 and FIG. 4, FIG. 2 and FIG. 5, FIG. 2 and FIG. 6, FIG. 2 and FIG. 7, FIG. 2 and FIG. 8, and FIG. 2 and FIG. 9 may be applied to the liquid crystal display of the present exemplary embodiment.

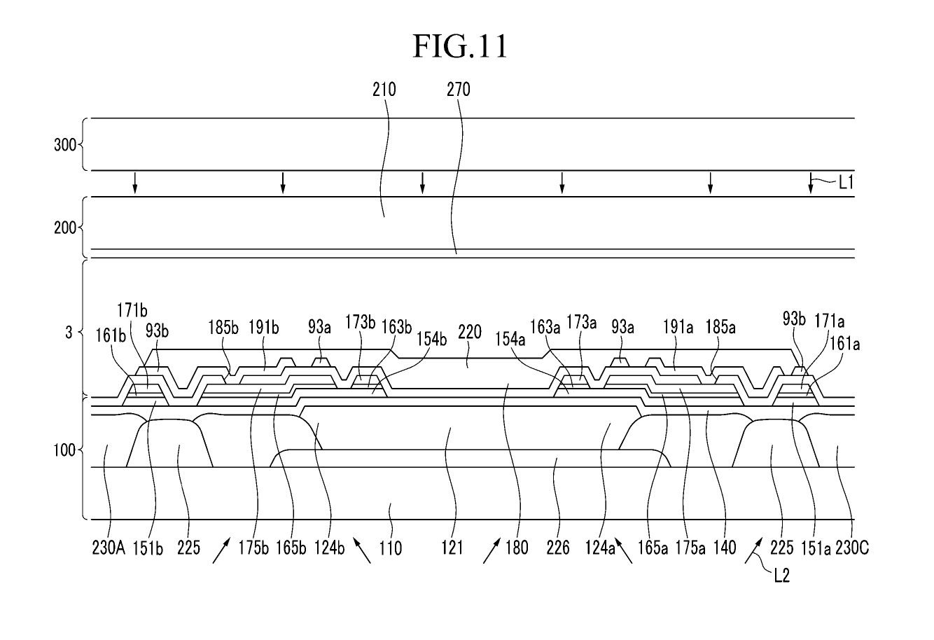

Next, a liquid crystal display according to another exemplary embodiment of the present invention will be described with reference to FIG. 11. FIG. 11 is a cross-sectional view of a liquid crystal display according to another exemplary embodiment of the present disclosure of invention taken along the line III-III of FIG. 2.

Referring to FIG. 11, the liquid crystal display according to the present exemplary embodiment is similar to the liquid crystal displays of the exemplary embodiments described with reference to FIG. 2 and FIG. 3, FIG. 2 and FIG. 4, FIG. 2 and FIG. 5, FIG. 2 and FIG. 6, FIG. 2 and FIG. 7, FIG. 2 and FIG. 8, FIG. 2 and FIG. 9, and FIG. 2 and FIG. 10. A detailed description of like constituent elements will be omitted.

Referring to FIG. 11, the liquid crystal display the present exemplary embodiment includes the first display panel 100 and the second display panel 200 facing each other, the liquid crystal layer 3 interposed between the first display panel 100 and the second display panel 200, and the backlight unit 300 positioned outside (behind) the second display panel 200.

The first display panel 100 will be described.

In the case of the liquid crystal display according to the present exemplary embodiment, like the exemplary embodiment shown in FIG. 7, the second light blocking member 225 is formed on the first insulation substrate 110. The second light blocking member 225 is disposed at the positions overlapped by the first data line 171a and by the second data line 171b. Also, the third light blocking member 226 is positioned on the first insulation substrate 110. The third light blocking member 226 is disposed on the position overlapped by the gate line 121 and by the protrusions of 154a and 154b of the first semiconductor 151a and the second semiconductor 151b forming the respective channels of the respective thin film transistors. Also, the color filters 230A, 230B, and 230C are not positioned at the region where the gate line 121 is positioned. Accordingly, the gate line 121 may be thickly formed to reduce its electrical resistance. By forming the thick gate line 121, the gate signal of the high resolution liquid crystal display may be transmitted without a signal delay.

Also, in the case of the liquid crystal display according to the present exemplary embodiment, the first insulating layer 180a is not positioned on the second light blocking member 225 and the plurality of color filters 230A, 230B, and 230C. A gate insulating layer 140 is positioned on the second light blocking member 225, the plurality of color filters 230A, 230B, and 230C, and the gate line 121. The gate insulating layer 140 provides planarization over the curved tops of the color filters 230A, 230B, 230C and of the second light blocking member 225. The gate insulating layer 140 also prevents the pigment of the second light blocking member 225 and the plurality of color filters 230A, 230B, and 230C from being exposed, and the second light blocking member 225 and the plurality of color filters 230A, 230B, and 230C from being lifted.

While not shown in FIG. 11, optionally, a second gate insulating layer 141 may be provided and positioned on top of the gate insulating layer 140. The second insulating layer 141 may include the inorganic insulating layer or the organic insulator, and may be omitted.

A plurality of the first semiconductors 151a and the second semiconductors 151b are formed on the gate insulating layer 140 and the ohmic contacts 161a, 161b, 163a, 163b, 165a, and 165b are formed thereon.

The first data line 171a and the second data line 171b, and the first drain electrode 175a and the second drain electrode 175b, are formed on the ohmic contacts 161a, 161b, 163a, 163b, 165a, and 165b and the gate insulating layer 140.

The second passivation layer 180 made of silicon nitride or silicon oxide is formed on the data lines 171a and 171b, the drain electrodes 175a and 175b, and the exposed semiconductors 151a and 151b. A plurality of pixel electrodes 191 including the first sub-pixel electrode 191a and the second sub-pixel electrode 191b, and a connection portion 93 are formed on the second passivation layer 180.

Also, the first light blocking member 220 is not positioned in the second display panel 200, but rather in the first display panel 100.

The second display panel 200 will now be described. A common electrode 270 is formed on the second insulation substrate 210. The thin film transistor is not formed in the second display panel 200.

In the shown exemplary embodiment, the common electrode 270 is formed in the second display panel 200, however the present disclosure of invention is not limited thereto, and in the case of the liquid crystal display according to another exemplary embodiment of the present teachings, portions of the common electrode 270 may be formed in the first display panel 100 including a plurality of signal lines and a plurality of pixels PX connected thereto.

As described above, according to the liquid crystal display according to the present exemplary embodiment, the second light blocking member 225 is positioned on the first insulation substrate 110. The second light blocking member 225 is formed at the position overlapping the first data line 171a and the second data line 171b. Also, the third light blocking member 226 is formed on the first insulation substrate 110. The third light blocking member 226 is disposed on the position overlapped by the gate line 121 and by the protrusions of 154a and 154b of the first semiconductor 151a and the second semiconductor 151b forming the channels of the thin film transistors. Also, the color filters 230A, 230B, and 230C are removed at the region where the gate line 121 is positioned. Accordingly, the gate line 121 may be thickly formed. By forming the thick gate line 121, a gate signal of a high resolution liquid crystal display may be transmitted without a signal delay.

Also, the first insulating layer 180a is not positioned on the second light blocking member 225 and the plurality of color filters 230A, 230B, and 230C, and the gate insulating layer 140 prevents the pigment of the plurality of color filters 230A, 230B, and 230C from being exposed and the plurality of color filters 230A, 230B, and 230C from being lifted.

A backlight unit 300 is positioned outside (behind) the second display panel 200. The first light L1 emitted from the backlight unit 300 is about straightly propagated and is incident toward the second display panel 200. Next, the amount of the first light L1 is controlled according to the arrangement of the liquid crystal molecules in the liquid crystal layer 3, and the light incident to the side of the first display panel 100 and passing through the first insulation substrate 110 is recognized by the user.

At this time, the ambient second light L2 incident to the side of the first display panel 100 from the side of the user is absorbed by the color filters 230A, 230B, and 230C, and by the second light blocking member 225, and by the third light blocking member 226 positioned on the first insulation substrate 110 such that the light is not reflected by the gate line 121 and the data line 171. Accordingly, by preventing the light (e.g., L2) inflowed to the thin film transistor array panel from the outside from being reflected by the signal lines such as the gate line and the data line formed in the thin film transistor array panel, the display quality deterioration of the liquid crystal display due to the outside light may be prevented.

Also, the first light L1 incident from the backlight unit 300 is blocked by the first light blocking member 220 such that the light is not incident to the protrusions 154a and 154b of the first semiconductor 151a and the second semiconductor 151b forming the channels of the first thin film transistor Qa and the second thin film transistor Qb. Accordingly, a leakage current of the channels according to the light may be prevented.

Many characteristics of the liquid crystal display according to the exemplary embodiments described with reference to FIG. 2 and FIG. 3, FIG. 2 and FIG. 4, FIG. 2 and FIG. 5, FIG. 2 and FIG. 6, FIG. 2 and FIG. 7, FIG. 2 and FIG. 8, FIG. 2 and FIG. 9, and FIG. 2 and FIG. 10 may be applied to the liquid crystal display of the present exemplary embodiment.

As described above, in the liquid crystal displays according to exemplary embodiments of the present disclosure of invention, on the first insulation substrate of the thin film transistor array panel, after forming at least one of the color filter and the light blocking member, the gate line, the data line, and the pixel electrode are formed. Liquid crystal material s contained by the second insulation substrate formed as spaced apart and facing the first insulation substrate. The backlighting unit is positioned behind the second insulation substrate. Color filters and/or light blockers are positioned in front of reflective elements (e.g., data lines and gate lines) of the first display panel 100 so that outside ambient light is not reflected back to the user from such signal lines. As a result, the display quality deterioration of the image displayed through the common electrode panel and the thin film transistor array panel by the light of the backlight may be prevented.

While this disclosure of invention has been described in connection with what are presently considered to be practical exemplary embodiments, it is to be understood that the present teachings are not limited to the disclosed embodiments, but, on the contrary, the teachings are intended to cover various modifications and equivalent arrangements included within the spirit and scope of the teachings.

What is claimed is:

1. A liquid crystal display comprising:
a first insulation substrate;
a plurality of color filters positioned on the first insulation substrate;
a plurality of gate lines and a plurality of data lines positioned on the plurality of color filters;
a plurality of thin film transistors positioned above the plurality of color filters and connected to respective ones among the plurality of gate lines and among the plurality of data lines;
a plurality of pixel electrodes connected to respective ones of the thin film transistors;
a second insulation substrate spaced apart from and facing the first insulation substrate;
a liquid crystal layer positioned between the first insulation substrate and the second insulation substrate; and
a backlight unit positioned above the second insulation substrate,
wherein the thin film transistors are not formed on the second insulation substrate.

2. The liquid crystal display of claim 1, further comprising
a first insulating layer positioned on the plurality of color filters.

3. The liquid crystal display of claim 1, and comprising
a first light blocking member positioned on at least one of the first insulation substrate and the second insulation substrate,
wherein the first light blocking member is disposed at positions corresponding at least to respective channel portions of the respective thin film transistors.

4. The liquid crystal display of claim 3, further comprising
a second light blocking member formed on the first insulation substrate and positioned between a plurality of color filters, and
the second light blocking member being disposed at a position overlapping the data lines.

5. The liquid crystal display of claim 4, wherein
the second light blocking member is positioned under or on the plurality of color filters.

6. The liquid crystal display of claim 5, wherein
the plurality of color filters are excluded from a region overlapped by the gate line.

7. The liquid crystal display of claim 6, wherein
the gate line is thicker than the data line.

8. The liquid crystal display of claim 4, further comprising
a third light blocking member positioned between the first substrate and the gate line.

9. The liquid crystal display of claim 5, wherein
the plurality of color filters are formed to respective heights that in the vicinity of an adjacent gate line, are lower than the height of a top surface of the gate line.

10. The liquid crystal display of claim 9, wherein
the gate line is thicker than the data line.

11. The liquid crystal display of claim 1, further comprising
a second light blocking member formed on the first insulation substrate and positioned between the plurality of color filters,
wherein the second light blocking member is disposed at a position overlapped by a corresponding data line.

12. The liquid crystal display of claim 11, wherein
the second light blocking member is positioned under or on the plurality of color filters.

13. The liquid crystal display of claim 12, wherein
the plurality of color filters are excluded from a region overlapping the gate line.

14. The liquid crystal display of claim 13, wherein
the gate line is thicker than the data line.

15. The liquid crystal display of claim 14, further comprising
a third light blocking member positioned between the first substrate and the gate line.

16. The liquid crystal display of claim 12, wherein:
the plurality of color filters are formed to respective heights that in the vicinity of an adjacent gate line, are lower than the height of a top surface of the gate line.

17. The liquid crystal display of claim 16, wherein
the gate line is thicker than the data line.

18. The liquid crystal display of claim 1, wherein
the plurality of color filters are excluded from a region overlapping the gate line.

19. The liquid crystal display of claim 18, wherein
the gate line is thicker than the data line.

20. The liquid crystal display of claim 1, wherein
the plurality of color filters are formed to respective heights that in the vicinity of an adjacent gate line, are lower than the height of a top surface of the gate line.
